(19) United States
(12) Patent Application Publication
(10) Pub. No.: US 2023/0105146 A1
(43) Pub. Date: Apr. 6, 2023

(54) TECHNOLOGIES FOR AEROPONICS

(71) Applicant: Vertical Irrigation LLC, Fresno, CA (US)

(72) Inventor: Ethan Mora, Fresno, CA (US)

(21) Appl. No.: 17/766,199

(22) PCT Filed: Oct. 2, 2020
(86) PCT No.: PCT/US2020/054058

§ 371 Date: Apr. 1, 2022

Related U.S. Application Data
(60) Provisional application No. 62/910,353, filed on Oct. 3, 2019.

(51) Int. Cl. A01G 31/02

(52) U.S. Cl. CPC A01G 31/02

(57) ABSTRACT

A device includes: a tank storing a fluid; a reservoir in a gravitational receipt of the fluid from the tank; a mist source positioned within the reservoir such that the mist source generates a mist from the fluid contained in the reservoir based on the gravitational receipt; a valve controlling the gravitational receipt based on the fluid in the reservoir; a tray hosting a flora member; and a tube conveying the mist from the reservoir to the tray such that the flora member is exposed to the mist.

### CROSS-REFERENCE TO RELATED PATENT APPLICATIONS

This patent application claims a benefit of U.S. Provisional Pat. Application 62/910,353 filed 03 Oct. 2019; which is herein fully incorporated by reference for all purposes.

### TECHNICAL FIELD

This disclosure relates to aeroponics.

### BACKGROUND

There is a desire to enable various technologies for aeroponically growing a flora member (e.g., plant, fungus, mushroom, root, branch, leaves, fruits, vegetables, microgreens, sprouts), while minimizing water, nutrients, labor, or energy. However, these technologies are not known to exist. As such, this disclosure enables such technologies.

### SUMMARY

In some embodiments, a device includes: a tank storing a fluid; a reservoir in a gravitational receipt of the fluid from the tank; a mist source positioned within the reservoir such that the mist source generates a mist from the fluid contained in the reservoir based on the gravitational receipt; a valve controlling the gravitational receipt based on the fluid in the reservoir; a tray hosting a flora member; and a tube conveying the mist from the reservoir to the tray such that the flora member is exposed to the mist.

In some embodiments, a method includes: causing a valve to control a gravitational receipt of a fluid from a tank to a reservoir; causing a mist to be generated from the fluid in the reservoir based on the gravitational receipt; and causing the mist to be conveyed from the reservoir to a tray hosting a flora member such that the flora member is exposed to the mist.

### DESCRIPTION OF FIGURES

FIG. 1 shows an embodiment of a tank according to this disclosure.

FIG. 2 shows an embodiment of a valve according to this disclosure.

FIG. 3 shows an embodiment of a fitting according to this disclosure.

FIG. 4 shows an embodiment of a fitting according to this disclosure.

FIG. 5 shows an embodiment of a tray according to this disclosure.

FIG. 6 shows an embodiment of a tube according to this disclosure.

FIG. 7 shows an embodiment of a plate according to this disclosure.

FIG. 8 shows an embodiment of a reservoir according to this disclosure.

FIG. 9 shows an embodiment of a set of tubes according to this disclosure.

FIG. 10 shows an embodiment of a mist source according to this disclosure.

FIG. 11 shows an embodiment of a lid enclosing a tray according to this disclosure.

FIG. 12 shows an embodiment of a tank according to this disclosure.

FIG. 13 shows an embodiment of a tube according to this disclosure.

FIG. 14 shows an embodiment of a fitting according to this disclosure.

FIG. 15 shows an embodiment of a valve according to this disclosure.

FIG. 16 shows an embodiment of a fitting according to this disclosure.

FIG. 17 shows an embodiment of a tube according to this disclosure.

FIG. 18 shows an embodiment of a set of tracks on a plate according to this disclosure.

FIG. 19 shows an embodiment of a first assembly configured for inputting a fluid into a reservoir according to this disclosure.

FIG. 20 shows an embodiment of a second assembly configured for inputting a fluid into a reservoir according to this disclosure.

FIGS. 21A-21C show an embodiment of a reservoir having a lid pivotally coupled thereto and a set of tubes extending from the lid and in fluid communication with the reservoir according to this disclosure.

FIG. 22 shows an embodiment of a reservoir having a tube extending therefrom according to this disclosure.

FIG. 23 shows an embodiment of a tray storing a set of pads, a plate for insertion into the tray over the set of pads, a reservoir with a lid, a set of tubes extending from the lid, and a mist source stored within the reservoir according to this disclosure.

FIG. 24 shows an embodiment of a tray storing a set of pads, a first lid of covering the tray, a reservoir with a second lid, a set of tubes extending from the second lid, and a mist source stored within the reservoir according to this disclosure.

FIG. 25 shows an embodiment of an assembly for configured for inputting a fluid into a reservoir according to this disclosure.

FIGS. 26A-26D show an embodiment of a mist source generating a mist from a fluid stored in a reservoir and a set of tubes guiding the mist to a tray according to this disclosure.

FIGS. 27A-27C show an embodiment of a tank gravitationally feeding a fluid to a reservoir storing a mist source such that the mist source generates a mist from the fluid and a set of tubes guides the mist to a set of flora members according to this disclosure.

FIG. 28 shows an embodiment of a set of tubes configured to receive a mist from a mist source within a reservoir and guide the mist to a set of flora members contained in a tray according to this disclosure.

FIG. 29 shows an embodiment of a mist source positioned within a reservoir where the mist source is corded while submerged within the reservoir and while a tank gravitationally feeds the reservoir according to this disclosure.

FIG. 30 shows an embodiment of a tray storing a plate hosting a set of pots with a set of flora members while the tray is positioned on a set of tracks secured to a plate according to this disclosure.

FIGS. 31A-31B show an embodiment of a mist source plugged into a wall outlet while being submerged in a fluid stored in a reservoir and while the mist source is generating a mist from the fluid and while a set of tubes guides the mist to a tray hosting a set of flora members according to this disclosure.

FIGS. 32A-32C show an embodiment of a container and a lid according to this disclosure.

FIG. 33 shows an embodiment of a tank and an assembly of tubes configured for gravitationally feeding a set of reservoirs containing a set of mist sources according to this disclosure.

FIG. 34 shows an embodiment of a platform having a set of shelves storing a set of reservoirs and a set of trays, where the set of reservoirs is gravitationally fed from a tank through an assembly of tubes according to this disclosure.

FIG. 35 shows an embodiment of a computing architecture according to this disclosure.

FIG. 36 shows an embodiment of a platform hosting a set of trays according to this disclosure.

FIG. 37 shows an embodiment of a platform hosting a set of trays (containers) with a set of flora members according to this disclosure.

FIG. 38 shows an embodiment of a platform hosting a set of trays (containers) with a set of flora members according to this disclosure.

FIGS. 39A-39B show an embodiment of an assembly for growing a set of flora members according to this disclosure.

FIG. 40 shows an embodiment of a platform hosting a set of trays (containers) with a set of flora members according to this disclosure.

### DETAILED DESCRIPTION

Generally, this disclosure enables various technologies for aeroponically growing a flora member (e.g., plant, fungus, mushroom, root, branch, leaves, fruits, vegetables, microgreens, sprouts), while minimizing water, nutrients, labor, or energy. For example, some of these technologies can include a tank storing a fluid (e.g., water, fertigation solution, liquid fertilizer); a reservoir in a gravitational receipt of the fluid from the tank; a mist source (e.g., an atomizer, a piezoelectric transducer, an ultrasonic nebulizer) positioned within the reservoir such that the mist source generates a mist (e.g., atomized particles, water vapor, fog) from the fluid contained in the reservoir based on the gravitational receipt; a valve (e.g., a float valve, a ball valve) controlling the gravitational receipt based on the fluid in the reservoir; a tray hosting a flora member; and a tube conveying the mist from the reservoir to the tray such that the flora member is exposed to the mist. These technologies are technically advantageous for various reasons. For example, some of these technologies solve various problems related to a high-pressure nutrient solution delivery by utilizing the reservoir that is gravity-fed and supplying the mist source with the fluid. This configuration can reduce or minimize energy consumption by reducing or eliminating some need for pumps, while also decreasing a number of replaceable parts involved in fertigation (or other agricultural) applications because of lack of or minimization of use of nozzle misters, which can be prone to clogging with mineral residue buildup. Further, this configuration can decrease a likelihood of root rot in a growth cycle of the flora member by keeping the flora member separate, isolated, or spaced apart from the reservoir, which can keep the flora members away from regularly stagnant water prone to bacterial growth. Note that this disclosure may be embodied in many different forms and should not be construed as necessarily being limited to various embodiments disclosed herein. Rather, these embodiments are provided so that this disclosure is thorough and complete, and fully conveys various concepts of this disclosure to skilled artisans.

Various terminology used herein can imply direct or indirect, full or partial, temporary or permanent, action or inaction. For example, when an element is referred to as being “on,” “connected,” or “coupled” to another element, then the element can be directly on, connected, or coupled to another element or intervening elements can be present, including indirect or direct variants. In contrast, when an element is referred to as being “directly connected” or “directly coupled” to another element, then there are no intervening elements present.

As used herein, various singular forms “a,” “an” and “the” are intended to include various plural forms (e.g., two, three, four, five, six, seven, eight, nine, ten, tens, hundreds, thousands) as well, unless specific context clearly indicates otherwise.

As used herein, various presence verbs “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled artisans understand that typically there is no limit on number of items or terms in any combination, unless otherwise apparent from the context.

As used herein, unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized or overly formal sense unless expressly so defined herein.

As used herein, relative terms such as “below,” “lower,” “above,” and “upper” can be used herein to describe one element’s relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/- 10% variation from a nominal value/term. Such variation is always included in any given value/term provided herein, whether or not such variation is specifically referred thereto.

Features described with respect to certain embodiments may be combined in or with various some embodiments in any permutational or combinatory manner. Different aspects or elements of example embodiments, as disclosed herein, may be combined in a similar manner.

Although the terms first, second, can be used herein to describe various elements, components, regions, layers, or sections, these elements, components, regions, layers, or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features described with respect to certain example embodiments can be combined and sub-combined in or with various other example embodiments. Also, different aspects or elements of example embodiments, as disclosed herein, can be combined and sub-combined in a similar manner as well. Further, some example embodiments, whether individually or collectively, can be components of a larger system, wherein other procedures can take precedence over or otherwise modify their application. Additionally, a number of steps can be required before, after, or concurrently with example embodiments, as disclosed herein. Note that any or all methods or processes, at least as disclosed herein, can be at least partially performed via at least one entity in any manner.

Example embodiments of this disclosure are described herein with reference to illustrations of idealized embodiments (and intermediate structures) of this disclosure. As such, variations from various illustrated shapes as a result, for example, of manufacturing techniques or tolerances, are to be expected. Thus, various example embodiments of this disclosure should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary, or be separately manufactured or connected, such as being an assembly or modules. Any or all elements, as disclosed herein, can be manufactured via any manufacturing processes, whether additive manufacturing, subtractive manufacturing, or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

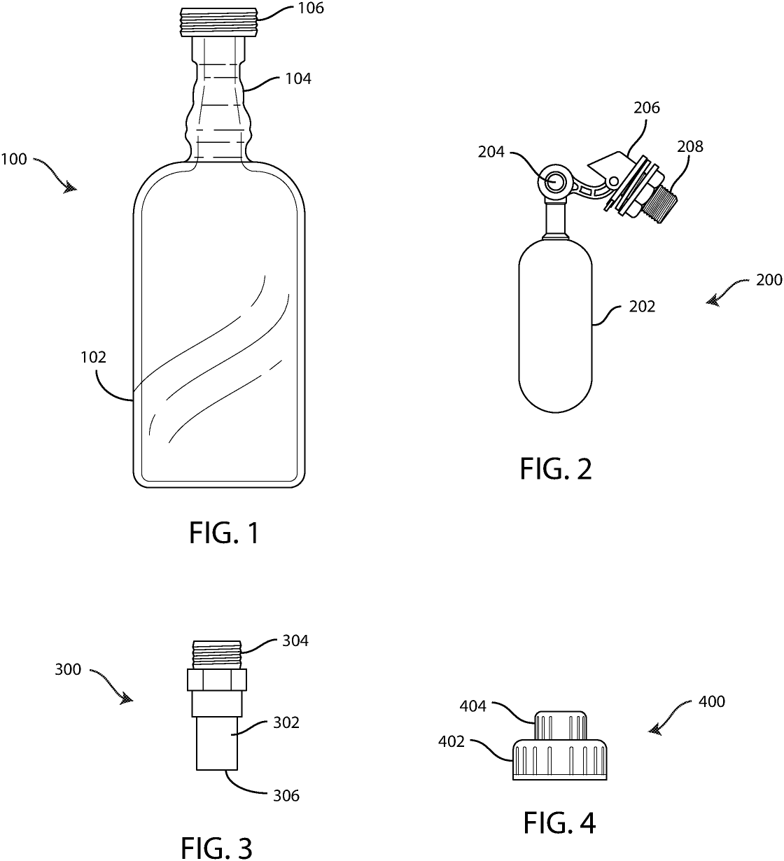

FIG. 1 shows an embodiment of a tank according to this disclosure. In particular, a tank 100, which can be a fertigation tank, includes a container 102 and a neck 104 extending from the container 102, whether monolithic or assembled therewith. The neck 104 has an open end portion 106, which is externally threaded, but can be internally threaded or non-threaded (e.g., smooth). The neck 104 extends along an internal rectilinear longitudinal axis, but can extend along an internal non-rectilinear longitudinal axis (e.g., arcuate, sinusoidal). Each of the container 102 and the neck 104 is opaque, but each can be transparent or translucent. The container 102 and the neck 104 includes plastic, but each can include other suitable materials (e.g., metal). The container 102 can contain a storage fluid (e.g., water, fertigation solution, liquid fertilizer) and output the storage fluid from the container 102 via the open end portion 106. Likewise, the container 102 can be filled with the storage fluid via the open end portion 106.

FIG. 2 shows an embodiment of a valve according to this disclosure. In particular, a valve 200 includes a float 202, a hinge 204, a door 206, and a fitting 208. The float 208 is configured to float in a misting fluid (e.g., water). The float 208 includes rubber, but can include other suitable materials (e.g., plastic). The hinge 204 is pivotally coupled to the float 202, whether monolithic or assembled therewith. The hinge 204 includes plastic, but can include other suitable materials (e.g., metal). The door 206 is coupled to the hinge 204 (e.g., via an arm), whether monolithic or assembled therewith. The door 206 includes plastic, but can include other suitable materials (e.g., metal). The fitting 208 is configured to couple (e.g., fasten) to an open end portion of a tube, whether rigid or flexible. The fitting 208 includes plastic, but can include other suitable materials (e.g., metal). The fitting 208 contains an inner channel through which the storage fluid can flow to become the misting fluid. As such, the valve 200 operates based on the door 206 selectively opening and closing via the hinge 204 based on the float 202 urging such actions when floating in the misting fluid relative to the fitting 208, whether the fitting 208 is floating in the misting fluid or not floating in the misting fluid. Therefore, the fitting 208 can output the storage fluid from the inner channel when the door 206 is open as urged via the float 202 floating in the misting fluid and can be precluded from outputting the storage fluid from the inner channel when the door 206 is closed as urged via the float 202 floating in the misting fluid. Although the valve 200 is embodied as a float valve, other types of valves can be used.

FIG. 3 shows an embodiment of a fitting according to this disclosure. In particular, a fitting 300 includes a tube 302 having an open end portion 304 and an open end portion 306 opposing the open end portion 304. Each of the tube 302, the open end portion 304, and the open end portion 304 includes plastic, but can include other suitable materials (e.g., metal). The open end portion 304 is externally threaded, but can be internally threaded or non-threaded (e.g., smooth). The open end portion 304 is configured to couple (e.g., fasten) to with the open end portion 106 such that a fluid path for the storage fluid is formed. The open end portion 306 is configured to couple to a valve (e.g., a ball valve, a float valve).

FIG. 4 shows an embodiment of a fitting according to this disclosure. In particular, a fitting 400 includes a tubular member 402 and a tubular member 406, where the tubular member 402 is wider in diameter than the tubular member 404, and the tubular member 402 extends from the tubular member 404. Each of the tubular member 402 and the tubular member 406 includes plastic, but can include other suitable materials (e.g., metal). The tubular member 402 has an open end portion configured to couple (e.g., fasten) to the open end portion 106. The tubular member 404 has an open end portion configured to couple (e.g., fasten) to the open end portion 306 such that a fluid path is formed.

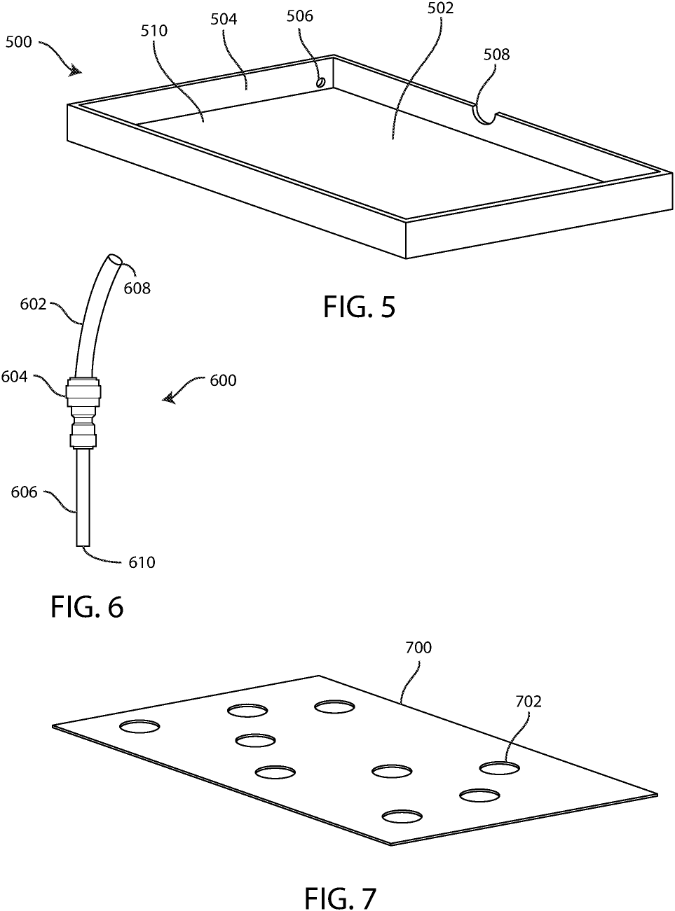

FIG. 5 shows an embodiment of a tray according to this disclosure. In particular, a tray 500 includes a base 502 and a sidewall 504 extending from the base 502, whether monolithic or assembled therewith, such that the sidewall 504 forms an enclosed area 510. Each of the base 502 and the sidewall 504 includes plastic, but can include other suitable materials (e.g., metal). Each of the base 502 and the sidewall 504 has a rectangular shape, but other suitable shapes are possible (e.g., square, circular, oval, triangular), whether identical or non-identical to each other (e.g., the base 502 is square and the sidewall 504 is circular). The base 502 is level (e.g., perpendicular) relative to the sidewall 504, but can be inclined, sloped, or angled relative to the sidewall 504, whether towards or away from the sidewall 504. For example, such incline, slope, or angle can be between about 0 degrees and about 90 degrees (e.g., less than about 5, 10, 15, 20, 25, 30, 35, 40, 45 degrees). The sidewall defines an opening 506, which is circular, but can be shaped differently, (e.g., square, triangle). Note that the base 502 can define the opening 506. When the base 502 is inclined, sloped, or angled relative to the sidewall 504, then the opening 506 can enable a gravitational drainage of a watering fluid (e.g., a mist liquid), which can be controlled by how inclined, sloped, or angled the base 502 is relative to the sidewall 504. The sidewall 504 defines a depression 508, which is concave towards the base 502. Note that the depression 508 is semi-circular, but can be shaped differently (e.g., U-shape, V-shape).

FIG. 6 shows an embodiment of a tube according to this disclosure. In particular, a tube 600 includes a tubular member 602, a fitting 604, and a tubular member 606, whether the fitting is monolithic or assembled with the tubular member 602 or the tubular member 606. The tubular member 602 has an open end portion 608 and the tubular member 606 has an open end portion 610. The fitting 604 is secured to the tubular member 602 and the tubular member 606 such that the open end portion 608 is in fluid communication with the open end portion 610 via the fitting 604. Each of the tubular member 602, the fitting 604, and the tubular member 606 includes plastic, but can include other suitable materials (e.g., rubber, silicon, metal). Each of the tubular member 602, the fitting 604, and the tubular member 606 is flexible, but can be rigid. The tubular member 602 is configured to extend into the opening 506 over the base 502. The fitting 604 is configured to contact (or avoid contact) with the sidewall 504 while the tubular member 602 extend over the base 502. The open end portion 608 is configured to receive the watering fluid while extending over the base 502 and guide the watering fluid via the tubular member 602 to the fitting 604, which in-turn guides the watering fluid to the open end portion 610 via the tubular member 604.

FIG. 7 shows an embodiment of a plate according to this disclosure. In particular, a plate 700 defines a set of openings 702 configured to receive a set of pots. The plate 700 includes plastic, but can include other suitable materials (e.g., metal, rubber). The set of openings 702 is identical in shape (circular) and size, but each of these characteristics can vary between at least two members of the set of openings 702. The set of openings 702 is randomly distributed on the plate 700. However, the set of openings 702 can also be arranged in a pattern (e.g., a grid, a two-dimensional open or closed shape).

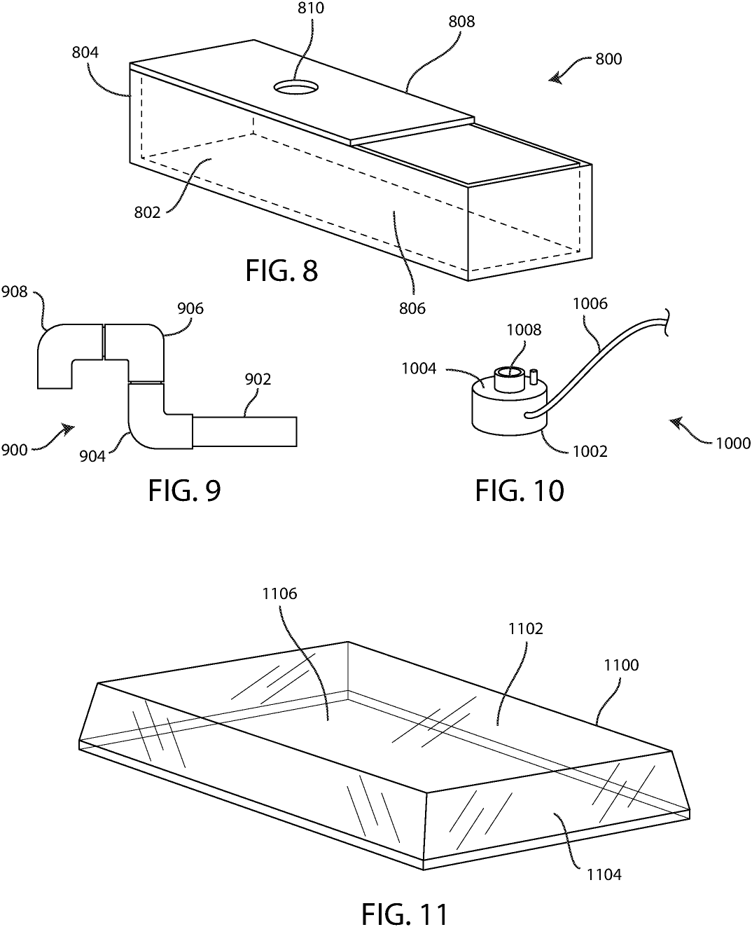

FIG. 8 shows an embodiment of a reservoir according to this disclosure. In particular, a reservoir 800 includes a base 802 and a sidewall 804 extending from the base 802, whether monolithic or assembled therewith, such that the sidewall 804 forms an enclosed area 806. Each of the base 802 and the sidewall 804 includes plastic, but can include other suitable materials (e.g., metal). Each of the base 802 and the sidewall 804 has a rectangular shape, but other suitable shapes are possible (e.g., square, circular, oval, triangular), whether identical or non-identical to each other (e.g., the base 802 is square and the sidewall 804 is circular). The base 802 is level (e.g., perpendicular) relative to the sidewall 804, but can be inclined, sloped, or angled relative to the sidewall 804. For example, such incline, slope, or angle can be between about 0 degrees and about 90 degrees (e.g., less than about 5, 10, 15, 20, 25, 30, 35, 40, 45 degrees).

The reservoir 800 includes a lid 808 controlling access to the enclosed area 806 and extending over the base 808, which can include extending over the sidewall 804. The lid 808 has a rectangular shape to match the base 802 in shape, but the lid 808 can have a non-rectangular shape (e.g., square, triangle, oval, circle, pentagon) or not match the base 802 in shape. The lid 808 includes plastic, but can include other suitable materials (e.g., metal, rubber). The lid 808 is opaque, but can be translucent or transparent. The lid 808 freely rests on the sidewall 804, but can be secured (e.g., fastened, magnetized) to the sidewall 804, which can be such that the lid 808 can pivot open and closed relative to the sidewall 804 (e.g., via a hinge), whether laterally or longitudinally. For example, the lid 808 can be monolithic with the sidewall 804 and can pivot via a living hinge. Note that the lid 808 can be configured to slide open and closed on the sidewall 804 relative to the sidewall 804. The lid 808 defines an opening 810, which is centrally positioned, although can be non-centrally positioned as well. The opening 810 is circular, but can be shaped differently (e.g., square, triangle).

The lid 808 avoids fully extending along the sidewall 804, thereby leaving an area of the reservoir 800 that is not covered by the lid 808. This area can be used for visual inspection, access to the enclosed area 806, or refilling. However, note that the lid 808 can fully extend along the sidewall 804 as well.

FIG. 9 shows an embodiment of a set of tubes according to this disclosure. In particular, a set of tubes 900 includes a tube 902 and a set of elbows 904, 906, 908. The tube 902 is rectilinear, but can be arcuate or sinusoidal. The tube 902 is rigid, but can be flexible. The tube 902 includes plastic, but can include other suitable materials (e.g., metal, rubber, silicon). Each member of the set of elbows 904, 906, 908 is rigid, but can be flexible. Each member of the set of elbows 904, 906, 908 includes plastic, but can include other suitable materials (e.g., metal, rubber, silicon). Within the set of elbows 904, 906, 908, the elbow 906 is secured (e.g., fastened, friction) to the elbow 904 and the elbow 908 such that the elbow 906 is sequentially positioned between the elbow 904 and the elbow 908. The tube 902 is secured (e.g., fastened, friction) to the elbow 904. As such, the elbow 908 and the tube 902 are in fluid communication with each other through the elbow 906 and the elbow 904 such that a mist can enter the elbow 908 and exit the tube 902 based on the mist traveling via the elbow 908, the elbow 906, the elbow 904, and the tube 902. Note the set of tubes 900 can be a single monolithic tube or the tube 902 and the elbow 904 can be in a single monolithic tube or at least two members of the set of elbows 904, 906, 908 can be a single monolithic tube.

FIG. 10 shows an embodiment of a mist source according to this disclosure. In particular, a mist source 1000 can be embodied as an atomizer, a piezoelectric transducer, an ultrasonic nebulizer, or another suitable mist source. The mist source 1000 includes a housing 1002 having a top side 1004 with an opening 1008 and a power cord 1006 extending from the housing 1002. The housing 1002 contains various electro-mechanical components configured to generate a mist (e.g., atomized particles, water vapor, fog) for output from the opening 1008. The electro-mechanical components receive an electrical power via the power cord 1006, which can be plugged into a wall outlet, a computer port, or other forms of sending the electrical power.

FIG. 11 shows an embodiment of a lid enclosing a tray according to this disclosure. In particular, a lid 1100 is configured to cover the tray 500. The lid 1110 has a base 1102 and a sidewall 1104 extending from the base 1102, whether monolithic or assembled therewith, such that the sidewall 1104 forms an enclosed area 1106. Each of the base 1102 and the sidewall 1104 includes plastic, but can include other suitable materials (e.g., metal). Each of the base 1102 and the sidewall 1104 has a rectangular shape, but other suitable shapes are possible (e.g., square, circular, oval, triangular), whether identical or non-identical to each other (e.g., the base 1102 is square and the sidewall 1104 is circular). The base 1102 is inclined, sloped, or angled relative to the sidewall 1104 (e.g., less than about 5, 10, 15, 20, 25, 30, 35, 40, 45 degrees), but can be level (e.g., perpendicular) relative to the sidewall 1104. Each of the base 1102 and the sidewall 1104 is transparent, but can be translucent or opaque.

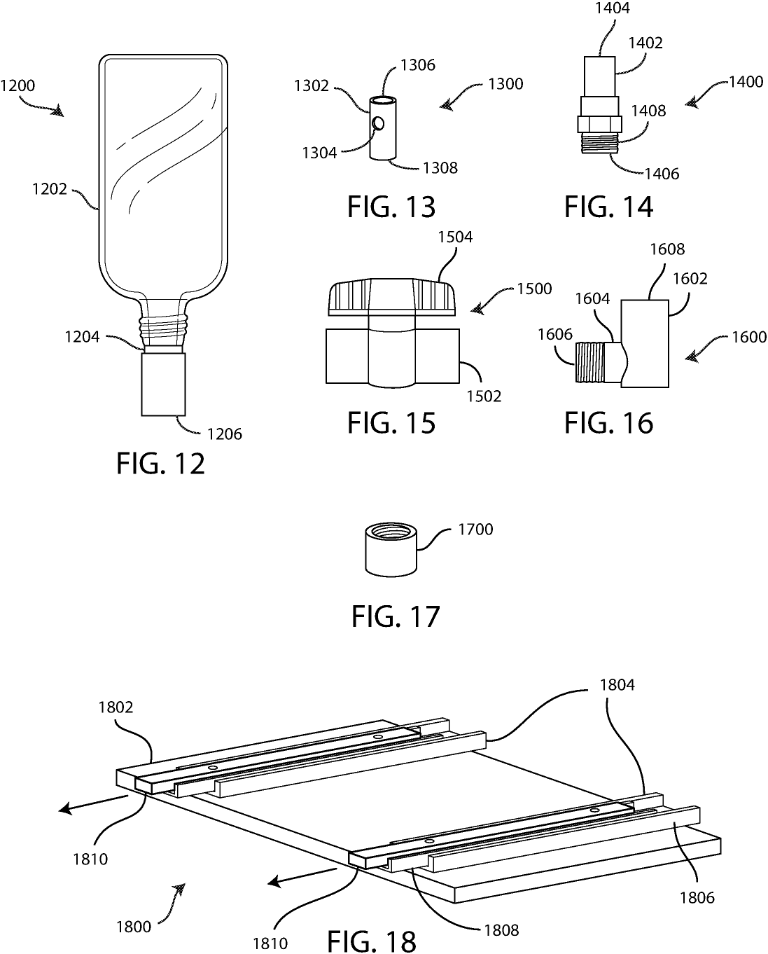

FIG. 12 shows an embodiment of a tank according to this disclosure. In particular, a tank 1200, which can be a fertigation tank, includes a container 1202 and a neck 1204 extending from the container 1202, whether monolithic or assembled therewith. The neck 1204 has an open end portion 1206. The neck 1204 extends along an internal rectilinear longitudinal axis, but can extend along an internal non-rectilinear longitudinal axis (e.g., arcuate, sinusoidal). Each of the container 1202 and the neck 1204 is opaque, but each can be transparent or translucent. The container 1202 and the neck 1204 includes plastic, but each can include other suitable materials (e.g., metal). The container 1202 can contain a storage fluid (e.g., water) and output the storage fluid from the container 1202 via the open end portion 1206. Likewise, the container 1202 can be filled with the storage fluid via the open end portion 1206.

FIG. 13 shows an embodiment of a tube according to this disclosure. In particular, a tube 1300 (e.g., assembly, monolithic) includes a sidewall 1302, an open end portion 1306, and an open end portion 1308. The sidewall 1302 defines an opening 1304, which is circular, but can be shaped differently (e.g., square, triangle). The tube 1300 includes plastic, but can include other suitable materials (e.g., metal, rubber).

FIG. 14 shows an embodiment of a fitting according to this disclosure. In particular, a fitting 1400 includes a tube 1402 (e.g., assembly, monolithic) having an open end portion 1404, an open end portion 1406, and a threaded portion 1408 extending between the open end portion 1404 and the open end portion 1408. The open end portion 1406 is configured to secure (e.g., fasten) to the open end portion 1206.

FIG. 15 shows an embodiment of a valve according to this disclosure. In particular, a valve 1500 is embodied as a ball valve, but can embodied in other form factors (e.g., a gate valve). The valve 1500 include a body 1502 containing a spherical ball (or another blocking object) that regulates a flow of a fluid therethrough (e.g., longitudinally left-to-right or right-to-left) and a handle 1504 rotationally coupled to the body 1502 such that the handle 1504 controls how the spherical ball is oriented within the body 1502 in order to regulate the flow of the fluid through the body 1502. Each of the body 1502 and the handle 1504 include plastic, but can include other suitable materials (e.g., metal, rubber). The spherical ball includes plastic, but can include other suitable materials (e.g., metal, rubber). The open end portion 1404 can secure (e.g., fasten, friction) with the body 1504. The open end portion 1306 can secure (e.g., fasten, friction) with the body 1504.

FIG. 16 shows an embodiment of a fitting according to this disclosure. In particular, a fitting 1600 includes a tube 1602 and a tube 1604, where the tube 1604 is non-parallel to the tube 1602 (e.g., perpendicular, acute, obtuse). The tube 1602 includes an open end portion 1608 and the tube 1604 includes an open end portion 1606. As such, the open end portion 1608 is in fluid communication with the open end portion 1606 via the tube 1602 and the tube 1604.

FIG. 17 shows an embodiment of a tube according to this disclosure. In particular, a tube 1700 can allow for a fluid (e.g., water) to flow therethrough or be embodied as an end cap which can be threaded into the open end portion 1606 in order to stop a flow of a fluid (e.g., water).

FIG. 18 shows an embodiment of a set of tracks on a plate according to this disclosure. In particular, a drawer assembly 1800 includes a board 1802 and a set of tracks 1804 secured to the board 1802 (e.g., nailing, fastening). The board 1802 includes plastic, but can include other suitable materials (e.g., metal, rubber). The board 1802 is rectangular, but can be shaped differently (e.g., square, oval). Each member of the set of tracks 1804 includes a U-shaped member 1806, a U-shaped member 1808, and a bar 1808. The U-shaped member 1808 is nested within the U-shaped member 1806 such that the U-shaped member 1808 can travel relative to the U-shaped member 1806. Likewise, the bar 1810 is nested within the U-shaped member 1808 such that the bar 1810 can travel relative to the U-shaped member 1808. The U-shaped member 1806 is secured to the board 1802 (e.g., nailing, fastening). The U-shaped member 1808 is secured to the U-shaped member 1806 (e.g., track within track) such that the U-shaped member 1808 can travel within the U-shaped member 1806 relative to the U-shaped member 1806. The bar 1810 is secured to the U-shaped member 1808 (e.g., track within track) such that the bar 1810 can travel within the U-shaped member 1808 relative to the U-shaped member 1808.

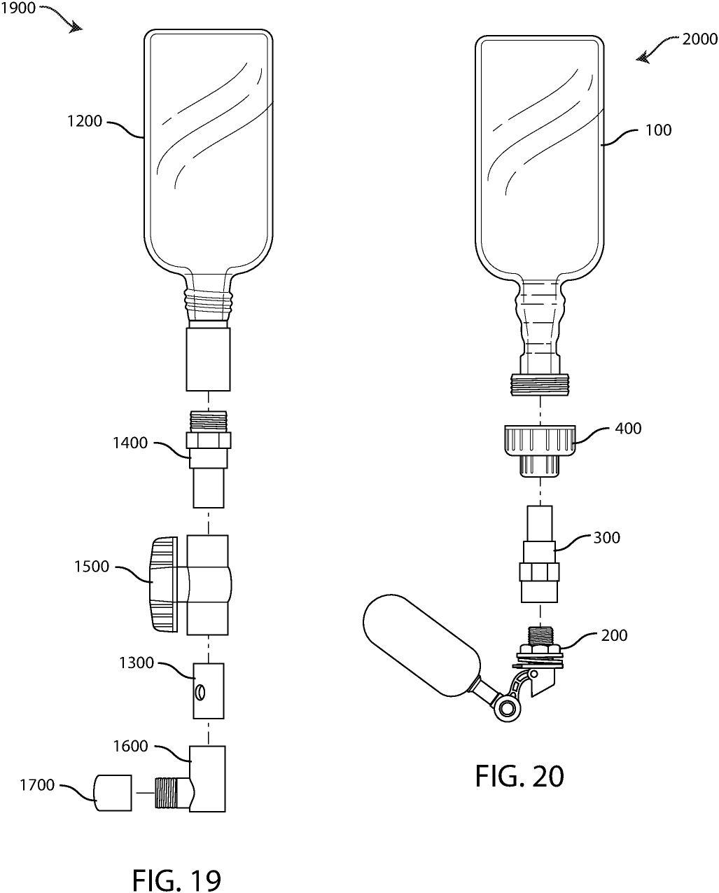

FIG. 19 shows an embodiment of a first assembly configured for inputting a fluid into a reservoir according to this disclosure. In particular, based on FIGS. 1-18, a first assembly 1900 is configured for gravitationally inputting the storage fluid into the reservoir 800 based on a fluid pressure (e.g., a gravitation receipt). The first assembly 1900 includes the tank 1200, the fitting 1400, the valve 1500, the tube 1300, the fitting 1600, and the tube 1700. The fitting 1400 is secured (e.g., fastened, friction) to the tank 1200 and to the valve 1500 such that the tank 1200 can output the storage fluid to the valve 1500 via the fitting 1400. The valve 1500 is secured (e.g., fastened, friction) to the fitting 1400 and the tube 1300 such that the fitting 1400 can output the storage fluid to the tube 1300 via the valve 1500, as the valve 1500 regulates how much of the storage fluid 1500 is output from the valve 1500. The tube 1300 is secured (e.g., fastened, friction) to the valve 1500 and the fitting 1600 such that the valve 1500 can output the storage fluid to the fitting 1600 via the tube 1300. The tube 1700 can convey the storage fluid from the fitting 1600 or stop the storage fluid from flowing when the tube 1700 is embodied as the end cap. As such, when the first assembly 1900 is inserted into the reservoir 800 such that the opening 1304 is in fluid communication with the enclosed area 806 that stores the misting fluid (previously the storage fluid), the tank 1200 gravitationally feeds the storage fluid based on the fluid pressure being equalized or imbalanced with the misting fluid in the reservoir 800.

FIG. 20 shows an embodiment of a second assembly configured for inputting a fluid into a reservoir according to this disclosure. In particular, based on FIGS. 1-18, a second assembly 2000 is configured for gravitationally inputting the storage fluid into the reservoir 800 based on the valve 200 being activated or open (e.g., a gravitational receipt). The second assembly 200 includes the tank 100, the fitting 400, the fitting 300, and the valve 200. The fitting 400 is secured (e.g., fastening, friction) to the tank 100 and the fitting 300 such that the tank 100 can output the storage fluid to the fitting 300 via the fitting 400. The fitting 300 is secured to the fitting 400 and the valve 200 such that the fitting 400 can output the storage fluid to the valve 200 via the fitting 300.

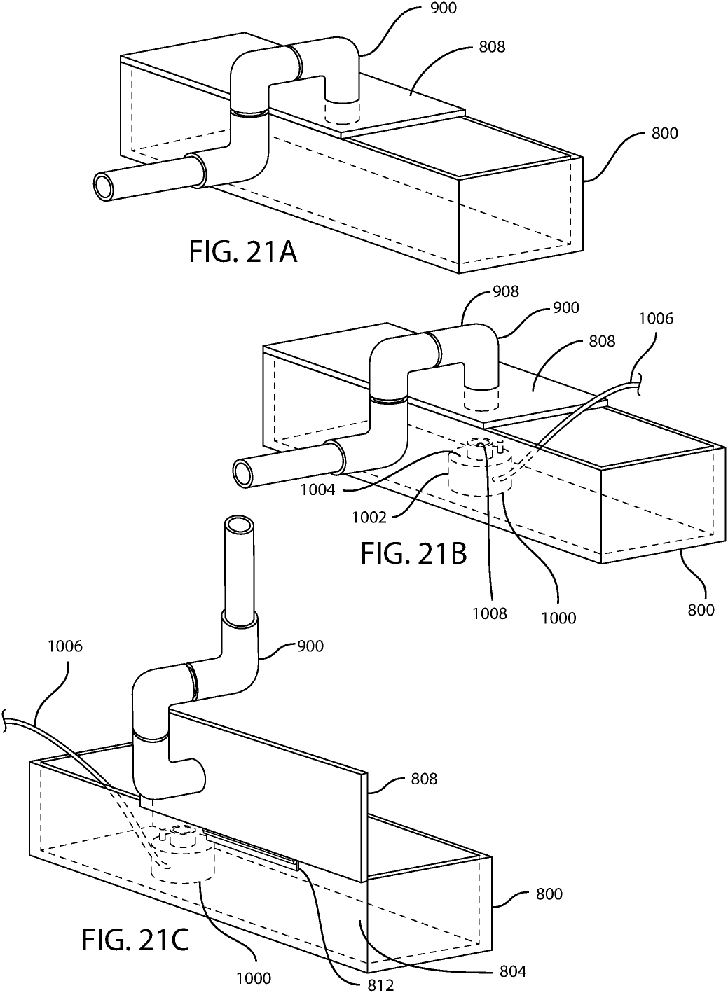

FIGS. 21A-21C show an embodiment of a reservoir having a lid pivotally coupled thereto and a set of tubes extending from the lid and in fluid communication with the reservoir according to this disclosure. In particular, the reservoir 800 includes the lid 808, the sidewall 804, and a hinge 812, where the hinge 812 is secured (e.g., fastened, nailed) to the lid 808 and the sidewall 808 such that the lid 808 can pivotally control access to the enclosed area 806, although the lid 808 can also be slidably secured to the sidewall 804. The reservoir 800 contains the mist source 1000 within the enclosed area 806, while the power cord 1006 extends out of the enclosed area 806 over the sidewall 804 and past the sidewall 804. The lid 808 has the set of tube 900 extending therefrom, whether monolithically or assembled therewith. When the lid 808 is closed (e.g., rests on the sidewall 804), the mist source 1000 is positioned under the lid 808 and, optionally, under the elbow 908. At that time, the top side 1004 faces the lid 808 and the elbow 908 such that the mist source 1000 can generate the mist, output the mist from the opening 1008, and cause or guide the mist to be input into the elbow 908 for conveyance via the set of tubes 900. When the lid 808 is open (e.g., perpendicular to the sidewall 804), the mist source 1000 is not positioned under the lid 808 and the elbow 908.

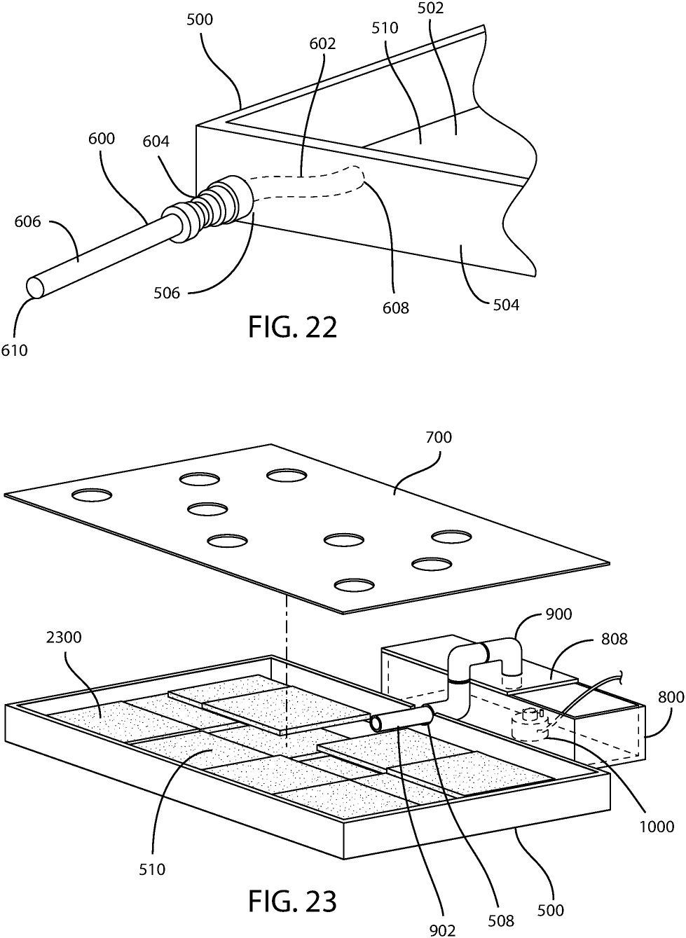

FIG. 22 shows an embodiment of a reservoir having a tube extending therefrom according to this disclosure. In particular, the tray 500 has the opening 506 through which the tubular member 602 extends over the base 502 into the enclosed area 510 to receive the watering fluid via the open end portion 608 and convey the watering fluid out of the enclosed area 510 to the open end portion 610 via the tubular member 602, the fitting 604, and the tubular member 606.

FIG. 23 shows an embodiment of a tray storing a set of pads, a plate for insertion into the tray over the set of pads, a reservoir with a lid, a set of tubes extending from the lid, and a mist source stored within the reservoir according to this disclosure. In particular, the tray 500 stores a set of pads 2300 within the enclosed area 510. The set of pads 2300 is stored stackably and adjacent to each other. Each member of the set of pads 2300 has a surface (e.g., upper) which the flora member can contact when growing, which can provide nutrients or stimulate growth. Each member of the set of pads 2300 includes a fibrous material, fabric, wood, hay, nylon, cellulose, enzymes, germinators, or some other suitable materials. The plate 700 is inserted into the enclosed area 510 such that the set of pads 2300 extends between the base 502 and the plate 700. The depression 508 is shaped to accommodate the tube 902, whether freely, frictionally, or snugly. The set of tubes 900 extends from the lid 808 such that the tube 902 extends over the depression 508 into the enclosed area 510 under the plate 700 such that the tube 902 extends between the plate 700 and the base 502 or at least one member of the set of pads 2300. As such, when the plate 700 holds a set of flora members (e.g., plants, fungi, mushrooms, roots, branch, leaves, fruits, vegetables, microgreens, sprouts) via the set of openings 702, then the set of flora members is can be exposed to the mist from the mist source 1000, as output via the tube 902. The plate 700 can contain the mist within the enclosed area 510 such that the set of flora members can be richly exposed to the mist. However, note that the tube 902 can extend over the plate 700 such that the plate 700 extends between the tube 902 and the base 502 or at least one member of the set of pads 2300.

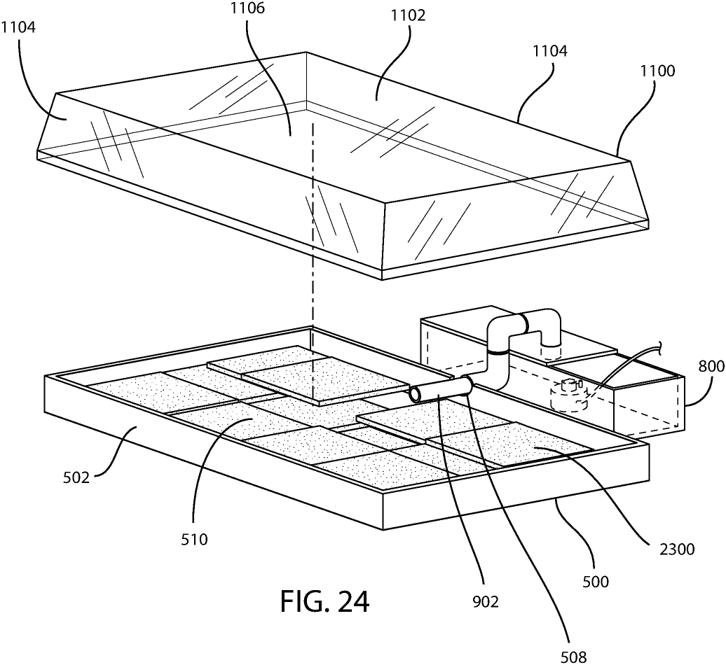

FIG. 24 shows an embodiment of a tray storing a set of pads, a first lid of covering the tray, a reservoir with a second lid, a set of tubes extending from the second lid, and a mist source stored within the reservoir according to this disclosure. In particular, the lid 1104 is placed onto the tray 500 such that the sidewall 1104 rests or engages (e.g., magnetizing, mating) the sidewall 502 and the enclosed area 510 faces the enclosed area 1106. During such placement, the base 1102 faces the set of pads 2300 or the base 502. Since the sidewall 1104 rests or engages the sidewall 502 when the lid is placed onto the tray 500, the tube 902 extends via the depression 508 over the set of pads 2300 into the enclosed area 510 such that the mist can enter the enclosed area 510 and the enclosed area 1106.

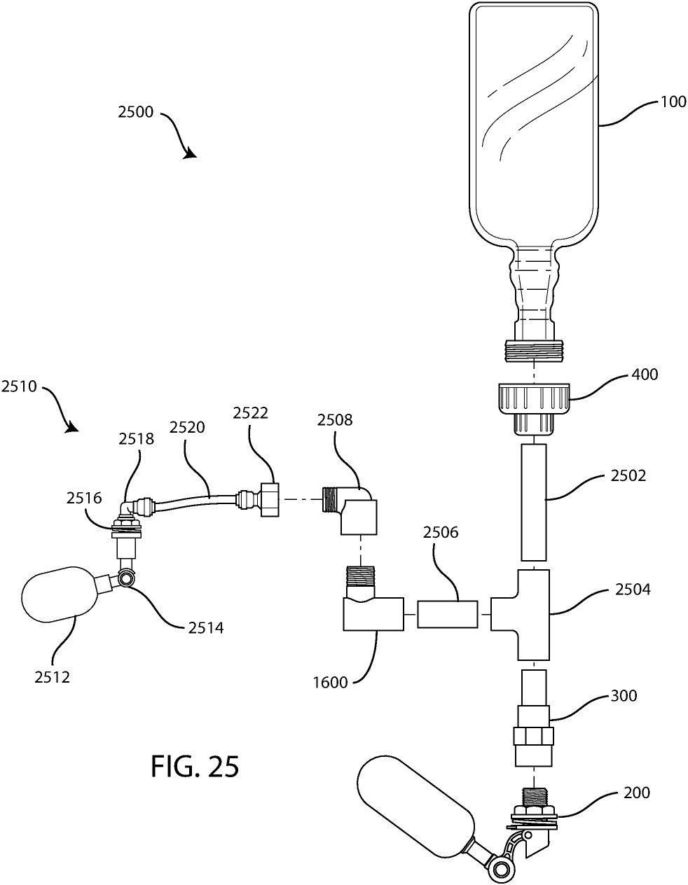

FIG. 25 shows an embodiment of an assembly for configured for inputting a fluid into a reservoir according to this disclosure. In particular, an assembly 2500 includes the tank 100 that is secured (e.g., fastened, friction) to the fitting 400. The fitting 400 is secured (e.g., fastened, friction) to a tube 2502 (e.g., plastic, metal). The tube 2502 is secured (e.g., fastened, friction) to a tee fitting 2504 (e.g., plastic, metal) secured (e.g., fastened, friction) to the fitting 300 and to a pipe 2506 (e.g., plastic, metal). Although the tee fitting 2504 is used, other fittings (e.g., L-shaped, J-shaped) can be used, whether alternatively or additionally. The fitting 300 is secured (e.g., fastened, friction) to the valve 200. The tube 2506 is secured (e.g., fastened, friction) to the fitting 1600. The fitting 1600 is secured (e.g., fastened, friction) to a fitting 2508 (e.g., plastic, metal). The fitting 2508 is secured (e.g., fastened, friction) to a valve 2510.

The valve 2510 includes a float 2512, a hinge 2514, a door 2516, a fitting 2518, a hose 2520, and a fitting 2522. The float 2512 is configured to float in a misting fluid (e.g., water). The float 2512 includes rubber, but can include other suitable materials (e.g., plastic). The hinge 2514 is pivotally coupled to the float 2512, whether monolithic or assembled therewith. The hinge 2514 includes plastic, but can include other suitable materials (e.g., metal). The door 2516 is coupled to the hinge 2514 (e.g., via an arm), whether monolithic or assembled therewith. The door 2516 includes plastic, but can include other suitable materials (e.g., metal). The fitting 2518 is configured to couple (e.g., fasten) to the hose 2520 (via an open end portion thereof). The hose 2520 can be rigid or flexible. The fitting 2518 includes plastic, but can include other suitable materials (e.g., metal). The fitting 2518 contains an inner channel through which the storage fluid can flow to become the misting fluid. The fitting 2522 is configured to couple (e.g., fasten) to the hose 2520 (via an open end portion thereof). The fitting 2522 includes plastic, but can include other suitable materials (e.g., metal). As such, the valve 2510 operates based on the door 2516 selectively opening and closing via the hinge 2514 based on the float 2512 urging such actions when floating in the misting fluid relative to the fitting 2518, whether the fitting 2518 is floating in the misting fluid or not floating in the misting fluid. Therefore, the fitting 2518 can output the storage fluid from the inner channel when the door 2516 is open as urged via the float 2512 floating in the misting fluid and can be precluded from outputting the storage fluid from the inner channel when the door 2516 is closed as urged via the float 2512 floating in the misting fluid.

Based on the tank 100 feeding the storage fluid to valve 200 and the valve 2510 via the tee fitting 2504, there can be a first reservoir 800 storing the valve 200 and a first mist source 1000 and a second reservoir 800 storing the valve 2510 and a second mist source 1000. As such, the tank 100 can be feeding the storage fluid to a set of reservoirs (and a set of mist sources).

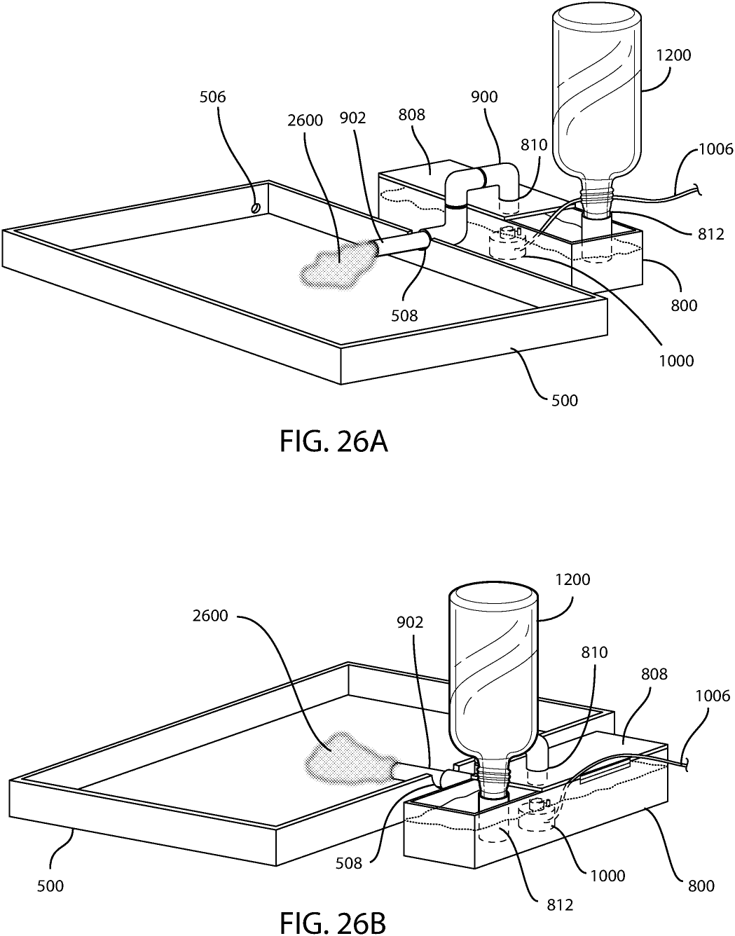

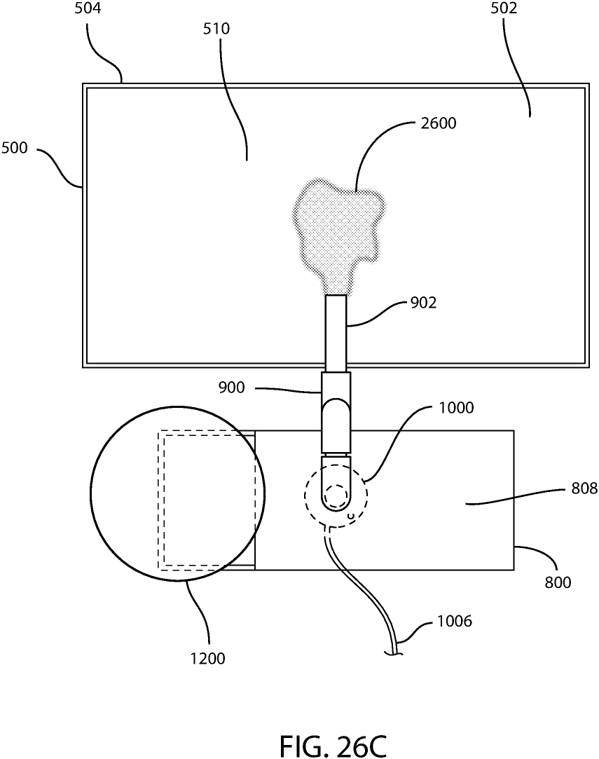

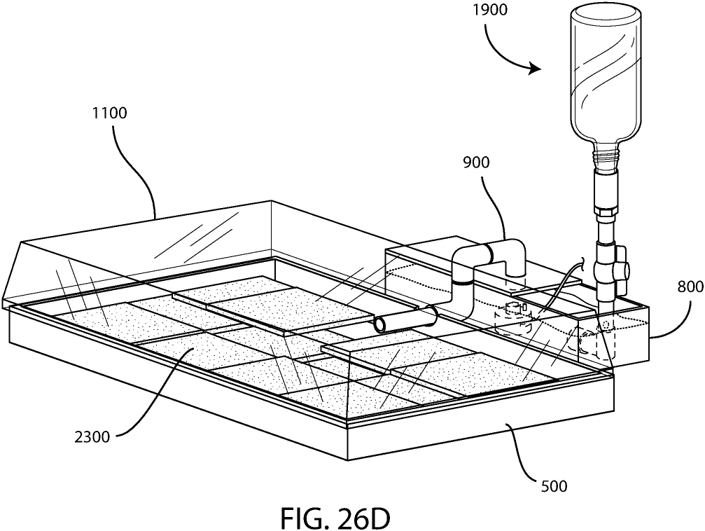

FIGS. 26A-26D show an embodiment of a mist source generating a mist from a fluid stored in a reservoir and a set of tubes guiding the mist to a tray according to this disclosure. In particular, the reservoir 800 includes a tubular portion 802 having a proximal end portion and a distal open end portion (or a sidewall hole). The proximal open end portion of the tubular portion 802 engages (e.g., fastening, friction, mating) the tank 1200 such that the storage fluid from the tank 1200 enters the tubular portion 802 and then enters the enclosed area 806 via the open distal end portion (or the sidewall hole), to become the misting fluid, which the mist source 1000 uses to generate the mist. The set of tubes 900 conveys the mist from the reservoir 800 into the enclosed area 510 under the plate 700, when the plate 700 is used.

More than one mist source 1000 can be contained in the reservoir 800. For example, the reservoir 800 can contain a set of mist sources 1000. The set of mist sources 1000 can generate a set of mists 2600 for input into the set tubes 900 or there can be a set of the set of tubes 900 corresponding to the set of mist sources 1000 (e.g., one-to-one correspondence). Note that the tray 500 can be irrigated by a set of mists 2600 from via a set of the set of tubes 900 from a set of reservoirs 800 with a set of mist sources 1000. For example, the each member of the set of tubes 900 can output a member of the set of mists 2600 from different directions of the tray 500 (e.g., opposing sides, adjacent sides) or from a same direction (e.g., each member of the set of tubes 900 is positioned side-by-side on a same side of the tray 500).

The lid 808 avoids fully extending along the sidewall 804, thereby leaving the area of the reservoir 800 that is not covered by the lid 808. This area can be used for visual inspection, access to the enclosed area 806, maintenance of the mist source 100, the float 202, or refilling the reservoir 800 with the misting fluid (e.g., from a hose or a container). However, the lid 808 can fully extend along the sidewall 804 as well. Note that when the tank 1200 is in fluid communication with the reservoir 800 via a hose line, then the hose line can enter the reservoir through the lid 808 or the area of the reservoir 800 that is not covered by the lid 808.

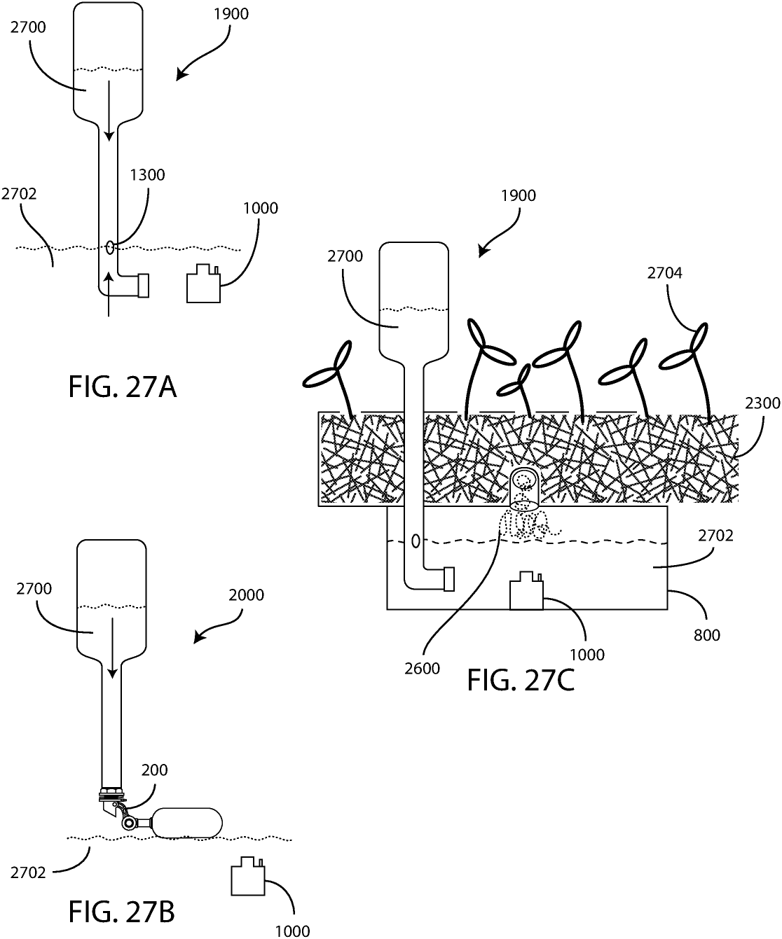

FIGS. 27A-27C show an embodiment of a tank gravitationally feeding a fluid to a reservoir storing a mist source such that the mist source generates a mist from the fluid and a set of tubes guides the mist to a set of flora members according to this disclosure. In particular, the first assembly 1900 includes the tank 1200 containing a storage fluid 2700 (e.g., water, fertigation solution, liquid fertilizer). The reservoir 800 contains a misting fluid 2702, which is formed when the storage fluid 2700 is fed into the reservoir 800 or when the misting fluid 2702 is filled into the reservoir 800 from a fluid source other than the tank 1200 (e.g., a hose or a container). The first assembly 1900 has the tube 1300 having the opening 1304, which enables a tension equilibrium between the storage fluid 2700 from the tank 1200 and the misting fluid 2702 in the reservoir 800 and creates an optimal water level. This configuration of the first assembly 1900 enables a control of how much of the storage fluid 2700 is fed from the tank 1200 as balanced against how much of the misting fluid 2702 remains in the reservoir.

In contrast, the second assembly 2000 controls how much of the storage fluid 2700 is fed from the tank 100 based on the valve 200 being activated and deactivated via the float 202 floating in the misting fluid 2702. Since the valve 200 has the door 206, which operates as a shut-off, then as the float 202 rises (or falls), the door 206 is activated (or deactivated), thereby halting (or enabling) the storage fluid 2700 from (to) being supplied from the tank 100. The float 202 rises or falls based on the mist source 1000 consuming the misting fluid 2702 in the reservoir 800. Regardless of how the storage fluid 2700 is controlled, when the mist source 1000 generates the mist 2600 from the misting fluid 2702 in the reservoir 800, then the mist source 1000 can cause the mist 2600 to travel away from the misting fluid into the set of tubes 900 for exposure to the flora members 2704 (e.g., plant, fungi, mushroom, roots, branch, leaves, fruits, vegetables, microgreens, sprouts).

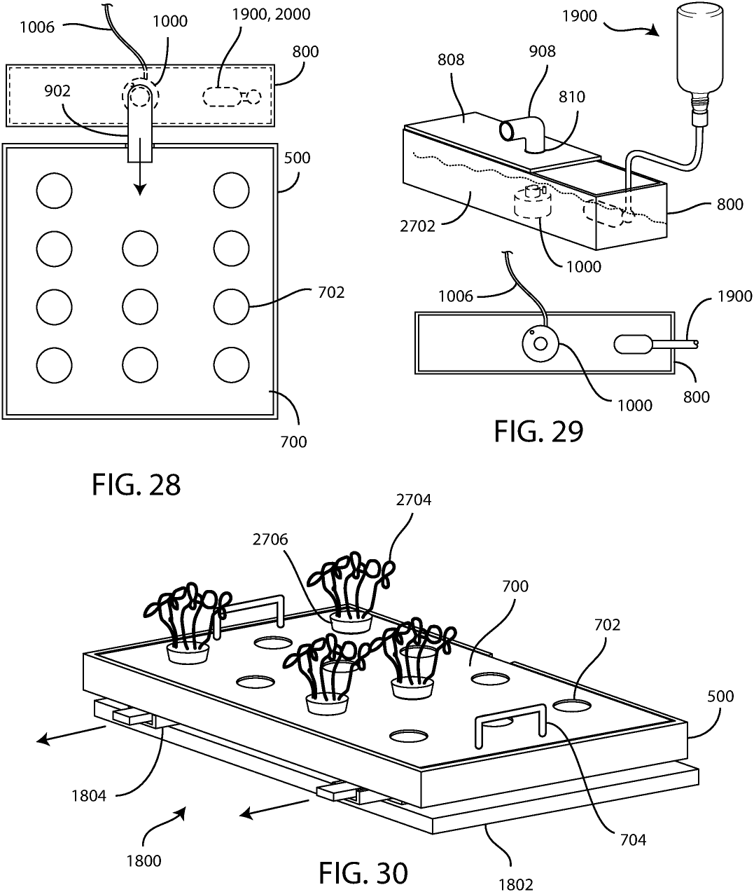

FIG. 28 shows an embodiment of a set of tubes configured to receive a mist from a mist source within a reservoir and guide the mist to a set of flora members contained in a tray according to this disclosure. FIG. 29 shows an embodiment of a mist source positioned within a reservoir where the mist source is corded while submerged within the reservoir and while a tank gravitationally feeds the reservoir according to this disclosure. In particular, the tube 902 extends over the plate 700 such that the plate 700 extends between the tube 902 and the base 502 or at least one member of the set of pads 2300, while the plate 700 rests on or within the base 500. The mist source 1000 is submerged within the misting fluid 2702 contained within the reservoir 800 such that the mist source 1000 is underneath the elbow 908 extending from the hole 810 of the lid 808. The power cord 1006 extends out of the reservoir 800.

FIG. 30 shows an embodiment of a tray storing a plate hosting a set of pots with a set of flora members while the tray is positioned on a set of tracks secured to a plate according to this disclosure. In particular, the plate 700 has the set of openings 702 hosting a set of pots, frames, or supporting structures 2706 containing a set of flora members 2704 (e.g., plant, fungus, mushroom, root, branch, leaves, fruits, vegetables, microgreens, sprouts). The plate 700 has a set of handles 704. Each member of the set of handles 704 is U-shaped, but can be shaped differently (e.g., L-shaped, J-shaped, V-shaped). The plate 700 rests on or positioned within the tray 500. The base 502 of the tray 500 is secured (e.g., fastened, nailed, mated, magnetized) to the tracks 1808 of the drawer assembly 1800 such that the tray 502 can slideably travel inward and outward relative to the board 1802.

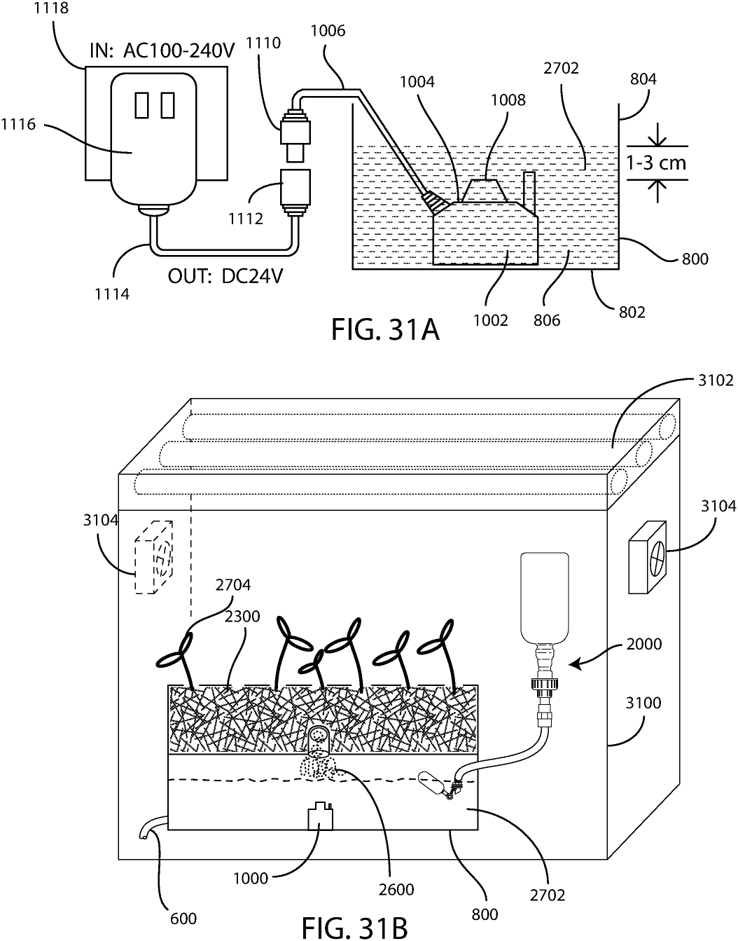

FIGS. 31A-31B show an embodiment of a mist source plugged into a wall outlet while being submerged in a fluid stored in a reservoir and while the mist source is generating a mist from the fluid and while a set of tubes guides the mist to a tray hosting a set of flora members according to this disclosure. In particular, the reservoir 800 has the base 802 and the sidewall 804 extending from the base 802 such that the enclosed area 806 is formed. The enclosed area 806 stores the misting fluid 2702. The mist source 1000 is submerged within the misting fluid 2702. For example, the misting fluid 270 can have a fluid surface and the mist source 1000 can be submerged between about 1 centimeter and about 3 centimeters from the fluid surface, although greater or lesser depths of submersions are possible.

The mist source 1000 includes the housing 1002 having the top side 1004 and the opening 1008. The power cord 1006 extends from the housing 1002. The power cord 1006 has a terminal end having a connector 1110 (e.g., a male port). The connector 1110 engages (e.g., mates) with a connector 1112 (e.g., a female port) located at a terminal end of a power cord 1114. The power cord 1114 spans between the connector 1112 and a power adapter 1116 configured for insertion into a receptacle of an electrical socket 1118. As such, the mist source 1000 is powered via an electric current that travels from the electrical socket 1118 to the housing 1002 through the power adapter 11116, the power cord 1114, the connector 1112, the connector 1110, and the power cord 1006. Note that the mist source 1000 can also be powered by a battery, which can be rechargeable.

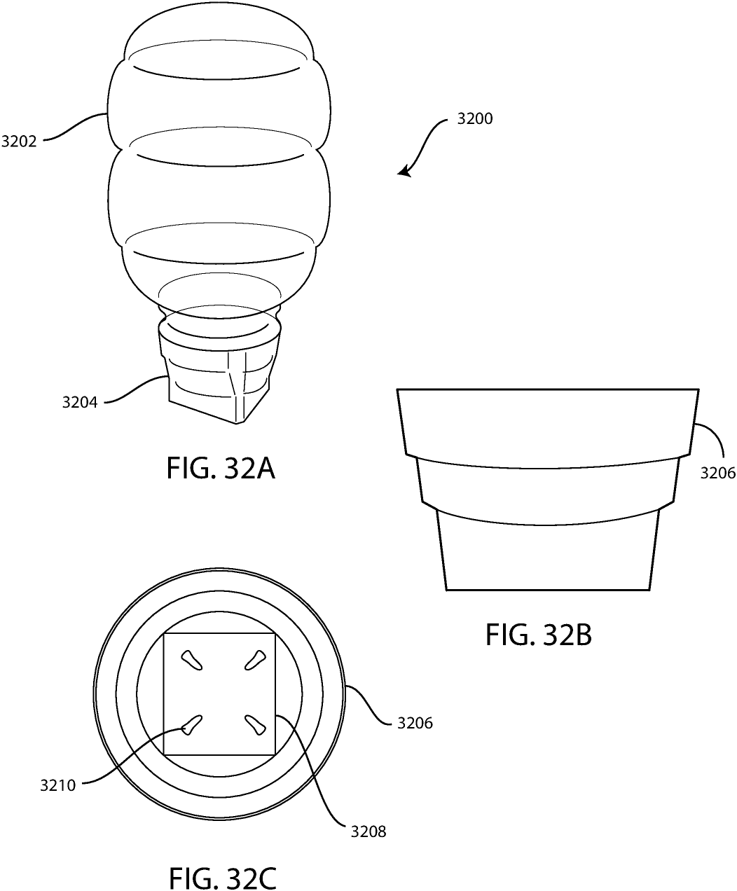

As shown in FIG. 32B, there is a chamber 3100 having a set of light sources 3102 and a set of fans 3104. The set of light sources 3102 can include a bulb, a diode, a light emitting diode, a fluorescent bulb, a black light bulb, or others. The set of light sources 3102 can illuminate in unison, one-at-a-time, flash, continuously, or change illumination parameters (e.g., color, intensity, dim, brighten). The set of light sources 3102 is positioned above the set of flora members 2704. The set of flora members 2704 are positioned within the tray 500 or the plate 700 over the set of pads 2300. The mist source 1000 generates the mist 2600 and the set of tubes 900 conveys the mist 2600 to the tray 500 or the plate 700 for exposure to the set of flora members 2704. The set of fans 3104 input, circulate, and output an ambient air into, with, and out of the chamber 3100. Each of the set of light sources 3102 and the set of fans 3104 can be powered via a mains power source or a battery, which can be rechargeable.

The second assembly 2000 has the tank 100 and a hose line (e.g., rubber, plastic, silicone) spanning between the tank 100 and the reservoir 800 such that the tank 100 is in fluid communication with the reservoir 800. The tank 100 feeds the storage fluid 2700 via the hose line to the reservoir 800. The tube 600 provides an outlet to a runoff chamber for an excess aqueous solution in which cuttings can be propagated.

FIGS. 32A-32C show an embodiment of a container and a lid according to this disclosure. In particular, a container 3200 includes a case 3202 and a lid 3204. The case 3204 is transparent, but can be opaque or translucent. The case 3202 includes glass, but can include other suitable materials (e.g., plastic, rubber, metal). The case 3202 can store the storage fluid 2700. The lid 320 has a sidewall 3206, a base 3208, and a set of holes 3210. The base 3208 is enclosed by the sidewall 3206. Each of the sidewall 3206 and the base 3208 can include plastic, but can include other suitable materials (e.g., rubber, metal). For example, the container 3200 can be situated next to the mist source 1000 where the container 3200 is positioned as an inverted refill container, where the inverted refill container can have a first hole, opening, or drain in the bottom and a second hole, opening, or drain in the side and being affixed or non-affixed to the inverted refill container with the bottom hole at least some amount (e.g., about 10 mm or less, about 10 mm or more) above the top side 104 of the mist source 1000. The first hole, opening, or drain can be circumferentially or perimetrically or volumetrically larger than the second hole, opening, or drain. The inverted refill container can have two or more pieces connected vertically, where the top piece having a threaded, push-connect, slip-connector, or spring-lock bottom consistent with the top of the bottom piece so as to be detachable, and the bottom piece having the holes in the bottom and the side.

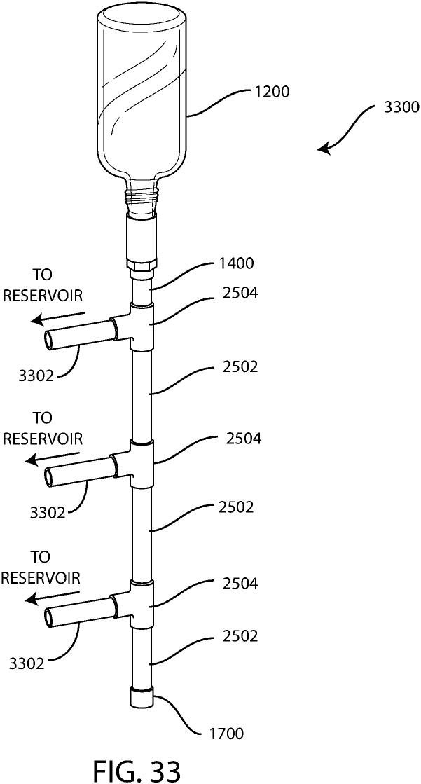

FIG. 33 shows an embodiment of a tank and an assembly of tubes configured for gravitationally feeding a set of reservoirs containing a set of mist sources according to this disclosure. In particular, an assembly of tubes 3300 includes the fitting 1400, a set of the tee fittings 2504, a set of the tubes 2502, the tube 700, and a set of tubes 3302. Each member of the set of tee fittings 2504 feeds at least one reservoir 800. The tank 1200 stores the storage fluid 2700 and is secured (e.g., fasten, friction) to the fitting 1400. Each member of the set of the tubes 2502 is secured (e.g., fastened, friction) to at least one member of the set of the tee fittings 2504. The tube 1700 is secured (e.g., fastened, friction) to the tube 2502. Therefore, the tank 1200 can gravitationally supply the storage fluid 2700 to a set of reservoirs 800 through the set of the tee fittings 2504 via the set of tube 300, whether the first assembly 1900 or the second assembly 2000 is used.

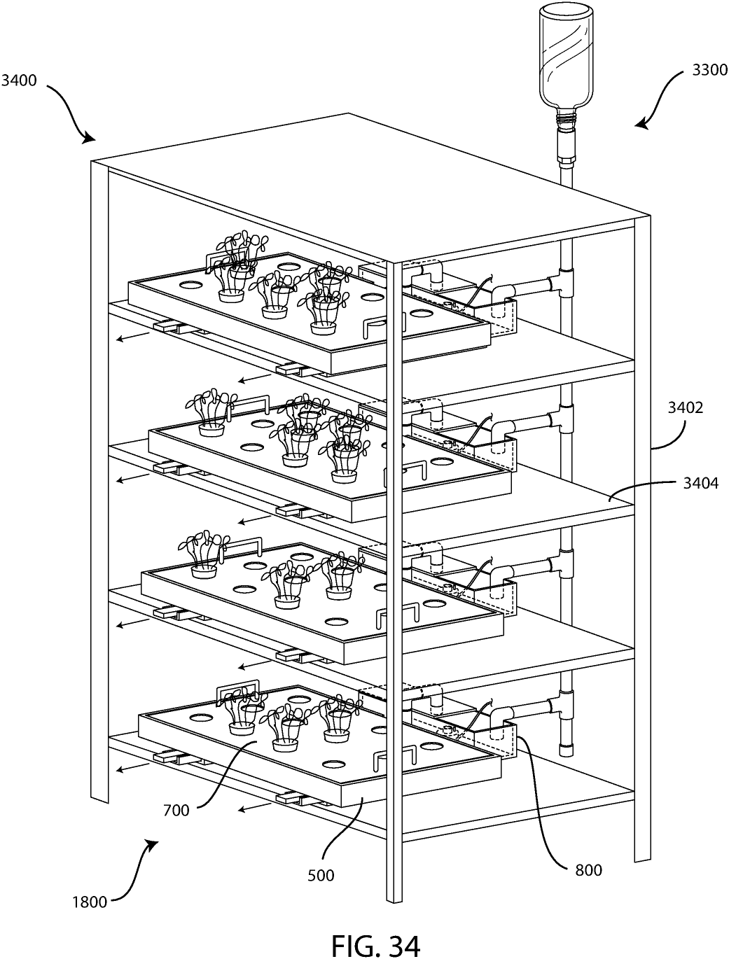

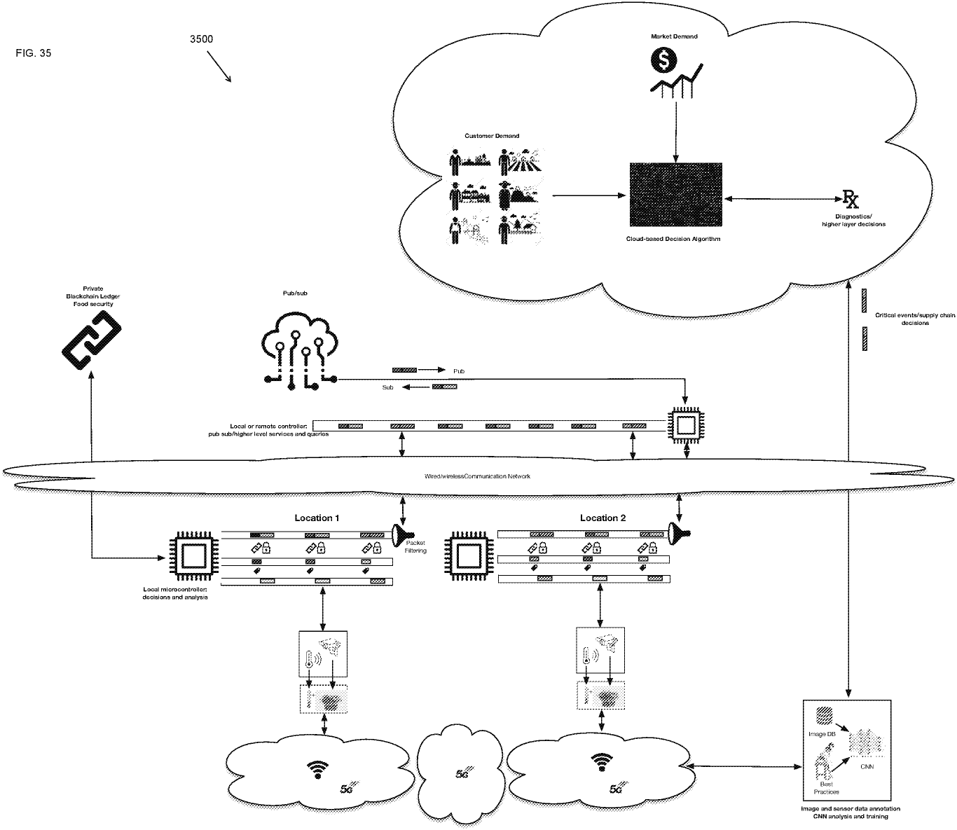

FIG. 34 shows an embodiment of a platform having a set of shelves storing a set of reservoirs and a set of trays, where the set of reservoirs is gravitationally fed from a tank through an assembly of tubes according to this disclosure. In particular, a platform 3400 includes a set of legs 3402 and a set of shelves 3404 secured (e.g., fastened, adhered, mated, friction) to the set of legs 3402, one above another such that each member of the set of shelves 3404 is spaced apart from another member of the set of shelves 3404. As such, each member of the set of shelves 3404 forms a level (or a floor) along a vertical plane that is capable of supporting a weight (e.g., between about 5 pounds and about 1,000 pounds but more or less is possible). Note that each member of the set of shelves 3404 is also the board 1802 from the drawer assembly 1800 that is secured to the set of legs 3402. As such, the platform 3400 hosts a set of trays 500 secured to the set of shelves 3404 (or a set of boards 1802) such that each member of the set of trays 500 can slide out and in relative to each respective member of the set of shelves 3404 based on a respective set of tracks 1804. Although the platform 3400 contains four levels (or floors), note that more or less levels (or floors) are possible (e.g., two, three, four, five, six, seven, eight, nine, ten, tens, hundreds, thousands).

Each member of the set of trays 500 hosts a respective tray 700 holding a respective set of flora members 2704. Each respective tray 700 rests or secured (e.g., fastened, mated, magnetized) on or in a respective tray 500. Each respective set of flora members 2704 is irrigated via a respective mist 2600 output from a respective set of tubes 900, whether the tube 902 extends over or under the respective tray 702. Each respective mist 2600 is generated by a respective mist source 2600 contained within a respective reservoir 800. Each respective reservoir 800 is gravitationally fed with the storage fluid 2700 via the assembly of tubes 3300 from the tank 1200. However, note that there can be multiple tanks 1200 each independently feeding each respective set of tubes 900. Also, note that although each level (or floor) hosts a single tray 500, each level (or floor) can host a set of trays 500 positioned side-by-side on that respective level (or floor), whether randomly or in a pattern (e.g., array, a line), whether longitudinally or laterally. For example, a level (or floor) can host a set of trays 500 in a front-to-back arrangement or a side-to-side arrangement. In such arrangements, other components can be correspondingly adjusted (e.g., a respective assembly of tubes 900 can extend over a first tray 500 without irrigating the first tray 500 but extend over a second tray 500 while irrigating the second tray 500).

Each member of the set of legs 3402 includes plastic, but can include other suitable materials (e.g., metal, glass). Each member of the set of shelves 3404 includes plastic, but can include other suitable materials (e.g., metal, glass). Although the platform 3400 does not have windows or sidewalls between the floors (levels), the platform 3400 can have windows or sidewalls between the floors (levels), whether in front, on sides, or in back.

Also, based on FIGS. 1-34, there is disclosed a machine learning assisted automated aeroponic grow chamber 3100 comprised of gravity-fed, pressure compensating aqueous solution dosing mechanism with solution delivery by an ultrasonic nebulizer 1000 and solution recapture by sloped runoff trap 606. For example, this disclosure enables various systems, devices, and methods for growing plants and fungi (e.g., edible mushrooms). These technologies can significantly reduce at least some amount of water or nutrients needed to stimulate growth, which can be organic or inorganic. Also, these technologies can reduce at least some amount of labor or energy consumption involved in the plant/mushroom growth process by automating water or nutrient solution dosing and runoff recapture. For example, some aeroponics methods employed in an irrigation system, as disclosed herein, can use significantly less water than hydroponic methods or traditional soil-medium irrigation methods.

There can be an aeroponic system for growing plants or fungi. The aeroponic system can comprise an unenclosed or enclosed chamber 3100 with at least one airtight or non-airtight door, where the chamber can be no smaller than 10 inches in height by 10 inches in width by 5 inches in length (although other dimensions whether higher or lower are possible). The chamber 3100 can have or can avoid having at least one set of light sources 3102 (e.g., LED light sources, incandescent light sources, halogenic light source, fluorescent light sources) affixed (permanently or temporarily) to a top side or a lateral side of an interior cavity of the chamber 3100.

The aeroponics system can comprise a container (e.g., tray 500) positioned within (or outside) the chamber 3100 for housing the microgreens or fungi (or other forms of flora whether edible or non-edible), where the container can have an angular or sloped bottom side (e.g., the base 502) that directs at least some flow of excess fluid (e.g., liquid, gas, water) in a direction of a hole, opening, or drain 506 that is punctured, defined, or installed in the container.

The aeroponics system can comprise a reservoir (e.g., the reservoir 800) positioned inside of the chamber 3100 to contain at least some fluid (e.g., liquid, gas, water, fertilizing solution, storage fluid). Internal to or external to the reservoir, whether attached or not attached thereto, the mist source 1000 (e.g., atomizer, piezoelectric transducer, ultrasonic nebulizer) can be positioned. The mist source 1000 can be or can avoid being situated next to an adjustable tension float valve (e.g., the valve 200), where the float valve can be fluidly connected by a hose line to a tank (e.g., the tank 100) affixed or not affixed to the chamber 3100 and at least partially vertically elevated above the reservoir (e.g., 4 inches or more, less than 4 inches). The tank can have a threaded bottom, push connecting bottom, slip-adapting bottom, slip-connecting bottom, or spring-lock bottom consistent with a hose line connector piece so as to be detachable (permanently or temporarily) from the hose line, with the float valve controlling or regulating at least some amount of fluid (e.g., liquid, gas, water, storage fluid, fertilizing solution) flowing from the tank into the reservoir such that the reservoir contains enough fluid to keep the mist source 1000 (e.g., atomizer, piezoelectric transducer, ultrasonic nebulizer) submerged with at least some amount of fluid above the mist source 1000 (e.g., 10-30 mm of liquid above mist source or less or more). However, note that such submersion is not required and can be avoided with the mist source 1000 being configured accordingly. The reservoir can be positioned inside the chamber 3100 to contain at least some fluid (e.g., liquid, gas, water, storage fluid, fertilizing solution) and, within the reservoir, there can be positioned the mist source 1000. Situated next to the mist source 1000, there can be an inverted refill container (e.g., the container 3200), where the refill container can have a first hole, opening, or drain in the bottom and a second hole, opening, or drain in the side and being affixed or non-affixed to the refill container with the bottom hole at least some amount (e.g., 10 mm or less, 10 mm or more) above the top of the atomizer. The first hole, opening, or drain can be circumferentially or perimetrically or volumetrically larger than the second hole, opening, or drain. The refill container can have two or more pieces connected vertically, where the top piece having a threaded, push-connect, slip-connect, or spring-lock bottom consistent with the top of the bottom piece so as to be detachable, and the bottom piece having the holes in the bottom and the side.

There can be an aeroponic system for growing plants or fungi (or other flora members). The aeroponics system can comprise a liquid-filled tank (e.g., the tank 100) connected by a hose line to a float valve (or a refill container) situated in an enclosed liquid-filled reservoir (e.g., the reservoir 800). In addition to the float valve, the reservoir can house the mist source 1000 (e.g., atomizer, piezoelectric transducer, ultrasonic nebulizer). Within the reservoir, the float valve can function to release a liquid from the tank into the reservoir when the liquid level in the reservoir drops below a preset level at which the mist source 1000, whether submerged or non-submerged, can create a mist (e.g., atomize) from the liquid in the reservoir. The reservoir can be situated within an enclosed chamber 3100 where a container (e.g., the tray 500 with or without the plate 700) of flora members (e.g., plants, fungi, edible, non-edible, microgreens, sprouts) is also situated. The tank is fluidly connected to the reservoir can be situated inside or outside of the chamber 3100.

The mist source 1000 (e.g., atomizer, piezoelectric transducer, ultrasonic nebulizer) can be connected (e.g., wired, wirelessly, waveguide, encrypted, non-encrypted) to a computer (e.g., microprocessor, multicore processor, controller, circuit board, programmable logic controller, field-programmable gate array) that controls at least some irrigation schedule, as disclosed herein. For example, the computer can include, be embodied as, or be coupled to a desktop, laptop, smartphone, tablet, embedded computer, vehicle computer, or other forms of computing. For example, the computer can include or be coupled to a wired or wireless network communication device (e.g., receiver, transmitter, transceiver, antenna). For example, the computer can include or be coupled to a sensor (e.g., temperature, pressure, humidity, conductivity, pH, motion, image, sound).

The mist source 1000 (e.g., atomizer, piezoelectric transducer, ultrasonic nebulizer) can be positioned within the reservoir below or underneath a pipe that can direct at least some atomized fluid (e.g., liquid, gas) into the container. The container may be of any suitable shape that permits the bottom part of the container to have a slope that uses gravity to direct at least some excess liquid accumulating in the bottom of the container toward the direction of a drainage hole, opening, or drain 506 cut into or near the bottom of the container (e.g., the base 502 or the sidewall 504). The hole, opening, or drain 506 in the container allows at least some excess liquid accumulating in the container to exit the container so that the liquid can be recycled back into the reservoir, which can include filtering, or into separate reservoir to be treated, filtered, or discarded. Note that although various angling of the slope is possible (e.g., oblique angle, non-oblique angle, acute angle, obtuse angle, right angle, between about 0 degrees and about 90 degrees), the precise angle of the slope in the bottom of the container may be specific to a flora organism being cultivated. For example, some accumulation of liquid solution in the bottom of the container may be desirable to encourage auxin production and the elongation of certain plant root systems (e.g., nutrient film technique fertigation).

The container may be completely enclosed so as to prevent the mist from escaping into the larger chamber, or alternatively, the container may allow the mist to enter the chamber 3100.

The irrigation or lighting schedule can be determined by the computer (e.g., microprocessor, multicore processor, controller, circuit board, programmable logic controller, field-programmable gate array) positioned on an outside or inside of the chamber 3100 or affixed or non-affixed thereto. For example, the computer can include, be embodied as, or be coupled to a desktop, laptop, smartphone, tablet, embedded computer, vehicle computer, or other forms of computing. For example, the computer can include or be coupled to a wired or wireless network communication device (e.g., receiver, transmitter, transceiver, antenna). For example, the computer can include or be coupled to a sensor (e.g., temperature, pressure, humidity, conductivity, pH, motion, image, sound). Like the mist source, at least one set of light sources (e.g., LED light sources, incandescent light sources, halogenic light source, fluorescent light sources) affixed (permanently or temporarily) can be connected to the computer to determine the irrigation or lighting schedule (e.g., light wavelength, light frequency, light intensity of light, light color, light luminosity, light brightness, light flashing frequency). The computer can broadcast (e.g., wired, wireless, waveguide, local, remote) at least some conditions of the chamber (e.g., air temperature, water temperature, humidity, pH of water or nutrient solution or fertigation solution, electrical conductivity of water or nutrient solution or fertigation solution, air pressure). When the sensor is an image sensor of a camera coupled to the computer, then the computer can broadcast (e.g., wired, wireless, waveguide, local, remote) photos or videos of the flora member (e.g., plants, fungi, mushrooms, microgreens, sprouts) taken by a camera inside of the chamber to a cloud-based database (e.g., relational, non-relational, in-memory, NoSQL). At least some data (e.g. files, streams, messages) broadcasted (e.g., wired, wireless, waveguide, local, remote) from the computer can be fed into a machine-learning algorithm (e.g., deep artificial neural network, convolutional artificial neural network, recurrent neural network, stateful neural network) that automatically makes at least some adjustments (e.g., parameters, characteristics, thresholds) to at least the irrigation or lighting schedule by communicating updated programmatic settings for the aeroponics system at predetermined intervals (e.g. on second, minute, hour, day, week basis). These adjustments can be made based on at least some content computationally extracted (e.g., computer vision) from the photos or videos of the flora member (e.g., this content can be visually informative whether that flora member growing, how much is that flora member growing, what direction is that flora member growing, at what rate is that flora member growing). Note that if the computer or the machine-learning algorithm is coupled to a plurality of aeroponics systems, then the computer or the machine learning algorithm can update various programmatic settings for the aeroponics systems, whether serially or in parallel, whether selectively or for all.

The aeroponics system can be used to grow plants, mushrooms, or other flora members, as disclosed herein. The mist can be directed into the container located within the chamber 3100. The container can have a removable lid, which can include a handle (e.g. U-shaped, L-shaped, J-shaped, C-shaped, O-shaped, D-shaped) affixed (e.g. fastened, mated, adhered, interlocked) on opposite or adjacent sides of a top or lateral side of the lid with a holes or opening defined therein, with a number of holes or openings determining a number of plants or plant pots or support structures, mushrooms or mushroom pots or support structures, or other flora members or other flora member pots or support structures in the chamber in any correspondence, whether one-to-one, one-to-many, many-to-one, or many-to-many.

Some of plant roots can be suspended in the container, which can be enclosed, with some stems of the plants or some leaves of the plants protruding or extending from the holes or the openings in the lid and exposed to at least some light, whether natural or artificial. For example, the light can be sourced from any light source described herein (e.g., LED bulb, LED strip, fluorescent bulb, incandescent bulb, halogen bulb).

The aeroponics system can be used to grow mushrooms, plants, or other flora members. The mist can be directed toward an amended block (e.g., sawdust) that has been colonized by mushroom mycelium (or another suitable life form). The amended block can be housed within the chamber in an enclosed capsule, where the capsule can be translucent or transparent to a certain degree so as to allow the mushroom mycelium (or another suitable life form) to be exposed to at least some light, whether natural or artificial. For example, the light can be sourced from any light source described herein (e.g., LED bulb, LED strip, fluorescent bulb, incandescent bulb, halogen bulb).

The aeroponics system can include wood, rubber, silicon, polyurethane, foam, shape-memory material, plastic, metal, glass, PVC, ABS, or materials in any components thereof.

The aeroponics system can be configured to aid in a flow direction or distribution of an atomized liquid. For example, the aeroponics system can include a fan 3104 (e.g., with blades, without blades) that can be affixed to or positioned sufficiently near a directional pipe that directs the atomized liquid into the container. The fan 3104 can be affixed to or be positioned near a directional pipe (e.g., above mist source) that can be placed in front of a gas tank (e.g., CO2, nitrogen) so as to supplement at least some nutrients in the mist.

The aeroponics system can be configured to grow plants or fungi at a commercial scale to grow plants, mushrooms, fungi, microgreens, sprouts, or other flora members within an existing structure (e.g. building, skyscraper, warehouse, farmhouse, hothouse, land vehicle, marine vehicle, aerial vehicle, space vehicle, submarine, manned vehicle, unmanned vehicle). For example, the aeroponics system can be configured to grow plants or fungi within a stand-alone chamber no larger than 30”x30”x30” (although these dimensions can vary whether greater or lesser).

The aeroponics system can be configured to employ a refill container, tank, or another water source (natural or artificial) or a float valve can be fluidly attached to a hose line connecting to a running water supply so that the reservoir refills from the water supply.

The aeroponics system can be configured to have the container to be positioned on a set of drawer slides (e.g., stationary, mobile, fixture) to allow an operator at least partially easier access to some, many, most, or all plants, fungi, mushrooms, or flora members in the chamber 3100. For example, the set of drawer slides can be from the drawer assembly 1800.

As explained above, a light source 3102 (e.g., LED bulb, LED strip, fluorescence bulb, incandescent bulb, halogen bulb) can have a multi-channel control function that allows the computer to adjust a color spectrum or intensity of light within the chamber 3100. Further, the aeroponics system can include a pH sensor or an electrical current sensor located in the reservoir or container, either or both of the sensors being connected to the computer. Additionally, the aeroponics system can include a temperature sensor or a humidity sensor in the chamber, either or both of the sensors being connected to the computer. Moreover, the chamber 3100 can include a fan 3102 used to blow air or cool at least some air temperature within the chamber 3100 and dissipate humidity by moving outside ambient air or air from within the chamber 3100 through or out of the chamber 3100, the fan 3102 being connected to the computer. Also, the aeroponics system can include a camera (e.g., PTZ, virtual PTZ, wide-angle, fisheye, infrared) affixed or not affixed to an inside of the chamber 3100 or directed toward the plants, fungi, mushrooms, or other flora members, the camera being connected to the computer or a separate computer broadcasting to a common database (e.g., cloud network, cloud-based database). The camera can stream or capture live on on-demand image (e.g., photo, video) of the plants, mushrooms, fungi, or other flora members at various times throughout a defined grow cycle and broadcast the imagery to a cloud-based database. The cloud-based database can allow a server (e.g., application server, virtual server, hardware server) to act based on such content to make decisions based on locally stored algorithms.

Various methods for aeroponically delivering aqueous solutions to plants and fungi are disclosed. Some of such methods can include an aqueous solution (e.g., liquid)-filled tank (e.g., the tank 100) gravitationally directing the aqueous solution downward through a hose connected to an adjustable pressure-compensating float valve (e.g., the valve 200) positioned a distance (e.g., less than 4 inches, more than 4 inches) below the tank. The adjusted pressure on the float valve can determine an amount of the aqueous solution flowing from the tank into the reservoir (e.g., the reservoir 800). A frequency with which the float valve allows liquid to flow from the tank into the reservoir can be determined by a displacement of the aqueous solution by at least one ultrasonic atomizer (or another form of mist source 1000) submerged (or not submerged) within the reservoir. The ultrasonic atomizer within the reservoir can resonate the aqueous solution above the ultrasonic atomizer’s piezoelectric disc and turning the aqueous solution into a mist, fog, or more gaseous state therefore displacing the aqueous solution from the reservoir. The mist rising vertically out of the reservoir into a “directional pipe” (e.g., the set of tubes 900) affixed to a top portion of the reservoir where a hole can be defined, and being positioned above the ultrasonic atomizer. An angle of the directional pipe directing the mist toward or into the container (e.g., the tray 500 with or without the plate 700) housing plants, plant roots, fungi, mushrooms, or other flora members. The angle, width, and length of the directional pipe determining at least some distribution of the mist, which can be aided or performed by a fan 3102. The container can be sized or airtight to determine a width or length of the directional pipe. The container can have a sloped bottom portion (e.g., the base 502 or the sidewall 504) with the slope angled toward a hole or opening (e.g., the opening 506) defined in the container thereby allowing some fluid (e.g. liquid, gas, water) accumulating in the container to drain. A frequency with which the ultrasonic atomizer (or another form of mist source 1000) turns on being determined by the computer or a humidity sensor positioned or secured within or on the container (e.g., the tray 500 or the plate 700). The computer can be programmed to turn the atomizer (or another form of mist source 1000) pursuant to a schedule or whenever a predefined humidity or moisture level is reached. The computer can be programmed to adjust for some desired conditions of a specific variant of plant, mushroom, fungi, or floral member being grown. At least some lights 3102 in the chamber 3100 are programmed to turn on and off in cycles consistent with an irrigation schedule set for the specific variant of plant, mushroom, fungi, or floral member.

As disclosed herein, the aeroponics system is technically advantageous for various reasons. For example, some embodiments of the aeroponics system can solve various problems related to high-pressure nutrient solution delivery by utilizing a gravity-fed reservoir combination with an atomizer (or another form of mist source 1000). This combination can reduce or minimize energy consumption by eliminating some need for pumps, while also decreasing a number of replaceable parts involved in fertigation (or other agricultural) applications because of lack of or minimization of use of nozzle misters, which can be prone to clogging with mineral residue buildup. Despite an inclusion of a reservoir in the system, the aeroponics system can decrease a likelihood of root rot in a plant (or other flora member 2700) growth cycle by keeping the plant (or other flora members 2700) separate or isolated or spaced apart from the reservoir, which can keep the plants (plant roots, seeds, or other flora members) away from regularly stagnant water prone to bacterial growth.

Note that FIG. 20 shows the second assembly 2000 componentially shown in FIGS. 1-4, where the second assembly 2000 is used for gravitationally feeding water (or another fluid 2700) from the tank 100 to the reservoir 800 based on an activation of a float valve (balloon device or the valve 200), as disclosed herein. The second assembly 2000 can be technologically advantageous when there are several containers 500 with the set of flora members 2704 being exposed to the mist 2600 from a common reservoir 800, as shown in FIGS. 33 and 34 (also see FIG. 25). In contrast, FIG. 19 shows the first assembly 1900 of FIGS. 12-17, where the first assembly 1900 is used for gravitationally feeding water (or another fluid 2700) from the tank 1200 to the reservoir 1800 based on a water pressure alone (see opening in the tube 1300 of FIGS. 13 and 19), where the tube 1300 with the valve 500 is used to control a flow from the tank 1200 to the reservoir 800, and the opening in the tube 1300 of FIGS. 13 and 19 is used to source water (or another fluid 2700) from the tank 1200 to the reservoir 800. The first assembly 1900 can be technologically advantageous when there is a single container 500 with the set of of flora members 2704 being exposed to the mist 2600 from a single reservoir 800, as shown in FIGS. 26A-30.

FIG. 35 shows an embodiment of a computing architecture according to this disclosure. In particular, a computing architecture 3500 is programmed for a gravity-fed fogponics technique that improves on various existing technologies. When the computing architecture 3500 is employed with various technologies, as disclosed herein, or other technologies, there is a vertical agricultural system formed that increases water-use efficiency when compared to traditional soil and other hydroponic methods of irrigation. Specifically, at least some water use efficiency (in the field) can be determined by dividing the amount of water transpired by the crop by the amount of water applied to the crop, and then multiplying that number by 100 to arrive at a percentage. However, this efficiency formula is difficult to apply in controlled environment agriculture settings, which generally utilize hydro/aeroponics, because in these settings, the water applied to the crops is recirculated. In traditional outdoor field applications, some, most, or all water not transpired is assumed lost. However, in the vertical agricultural system, as disclosed herein, in some embodiments, minimum or no water is lost unless the water supply itself somehow becomes contaminated and needs to be disposed. While the vertical agricultural system, as disclosed herein, in some embodiments, can be more efficient than field applications, the traditional efficiency formula may be inapplicable or unreliable or insufficiently precise for assessing efficiency rate among different hydro/aeroponic techniques. In some embodiments, a more accurate “efficiency” formula for soilless grow techniques, specifically, ought to determine the amount of wastewater at the end of each grow cycle.

Some hydroponic and many aeroponic systems will generally recirculate the fertigation solution applied from the reservoir to the plant roots and back into the reservoir container for continuous use. The amount of water and nutrient mix required for irrigation depends on the type of crop, but in most hydroponic and aeroponic systems, the water pumps involved must be sufficiently submerged in enough liquid to keep the pump from dry running (and breaking). This means that once a grow cycle is complete, or if the solution becomes severely imbalanced in its nutrient composition, the remaining solution — which must be enough to keep the pump submerged and the solution circulating— -becomes wastewater and must be properly disposed. Recirculating the solution after running the solution through the plant roots also presents a risk that root-borne diseases can spread from a single plant to all plants that share the same solution; in that instance, the solution would also become wastewater. In contrast, the vertical agricultural system, as disclosed herein, in some embodiments, is more efficient than other irrigation systems because the vertical agricultural system, as disclosed herein, in some embodiments, does not recirculate the nutrient/fertigation solution. Rather than pumping the nutrient solution through the pipes in the vertical agricultural system, as disclosed herein, in some embodiments, the vertical agricultural system, as disclosed herein, in some embodiments, distributes nutrient-dense fog through the pipes to the plant roots using a directed airflow (aero-flow distribution method). In this way, the vertical agricultural system, as disclosed herein, in some embodiments, keeps the roots moist, but not oversaturated, with only as much liquid as can cling to the roots. The small amount of excess solution delivered to the roots that does not cling to the rhizoids (or root hairs) falls to the bottom of the container where the plant roots hang, encouraging the plants to produce a hormone called auxin, which helps plant roots grow long. The remaining fertigation solution remains in the reservoir until it’s distributed.

One version of a mist source (e.g., an atomizer) used in the vertical agricultural system, as disclosed herein, in some embodiments, diffuses 200-400 ml (or 13.5 oz, or 0.11 gal) of water per hour (without using the aero-flow method, which may only be sometimes necessary for rapid solution distribution or multi-tiered units using the same fertigation solution supply). Therefore, if the mist source is submerged in a half-gallon water supply, then the mist source can run continuously on that supply for approximately 4.5 hours, absent any method for recapture and recirculation, which, as mentioned above, can risk spreading diseases. For example, a typical irrigation schedule for mint will provide the plants with about 30 minutes of water per day, which means the mist source can provide 7-9 days of water before it will need to be refilled. The only amount of wastewater produced by the vertical agricultural system, as disclosed herein, in some embodiments is the amount of fertigation solution that does not get atomized - that amount can be as low as about zero depending on the setup. This implies a near 100% efficiency rate according to both the traditional efficiency calculation formula, and the preferred formula, as disclosed herein. For example, at least some nutrient concentration is not lost when water from the reservoir is nebulized/atomized for distribution to the plant roots. In some embodiments, small droplets of fertigation solution or water — like those generated by fogponics — tend to be more effective than aerated flowing solutions of liquid when that liquid solution is used to grow plant cuttings (for propagation) and seedlings. This is because the gaseous state of the liquid does not impinge on the emerging and weak root structures of the young plants. In some embodiments, when fog or mist is distributed to free-hanging plant roots in soilless setups, the roots will also absorb more air than in traditional hydroponic systems or if the roots were buried in soil. Further, in some embodiments, the mist source 1000 is ultrasonic. As such, this serves several purposes beyond solution distribution. For example, the ultrasonic vibrations produced by the atomizer minimize or prevent liquid stagnation in the reservoir, which inhibits algae and bacterial growth in the reservoir.

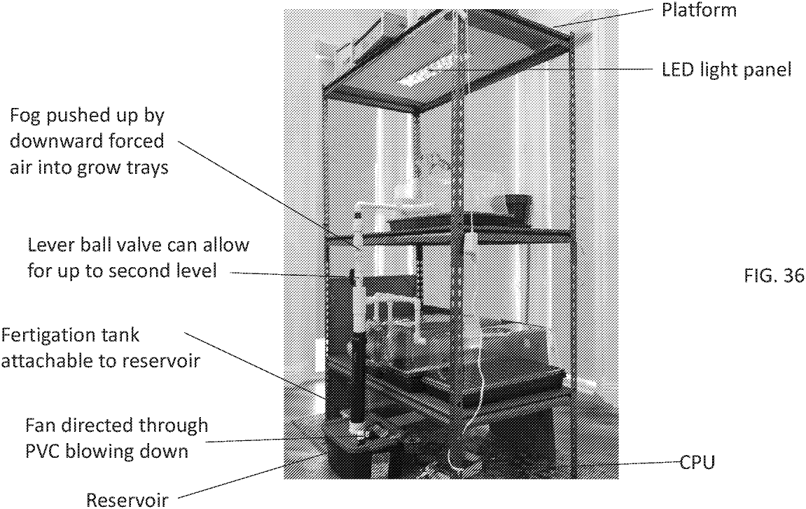

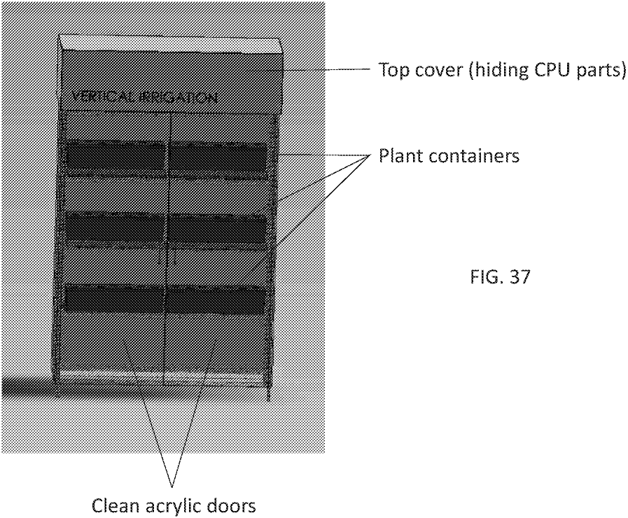

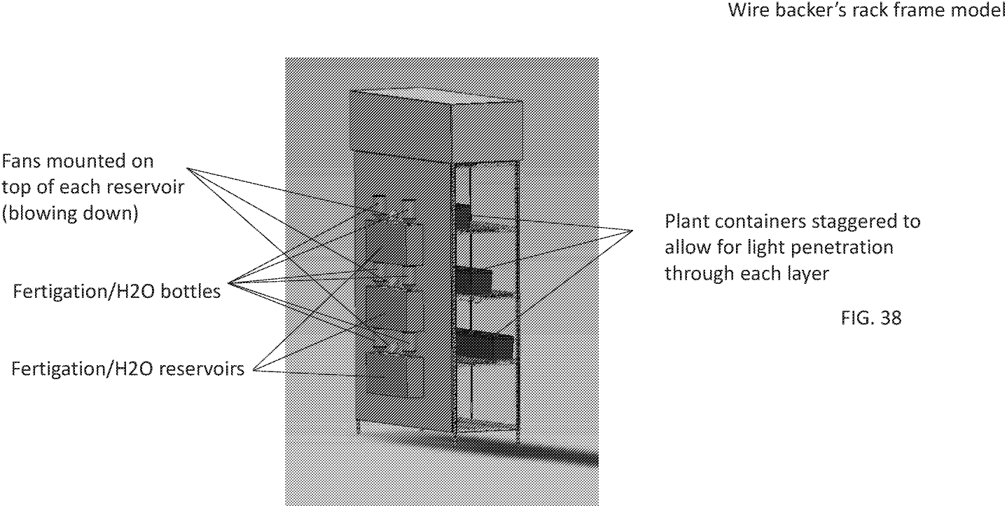

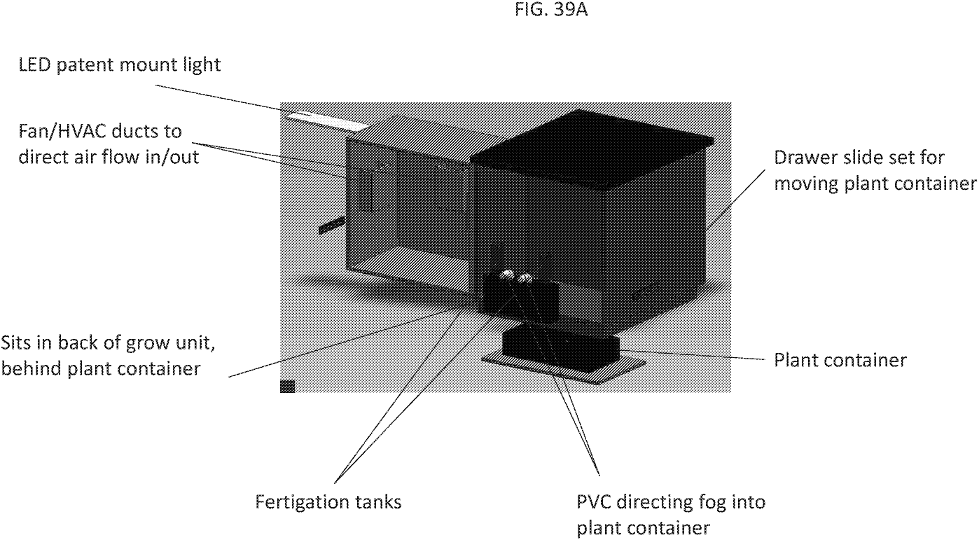

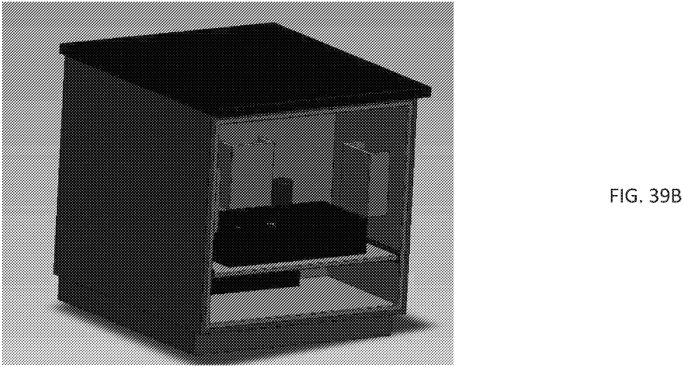

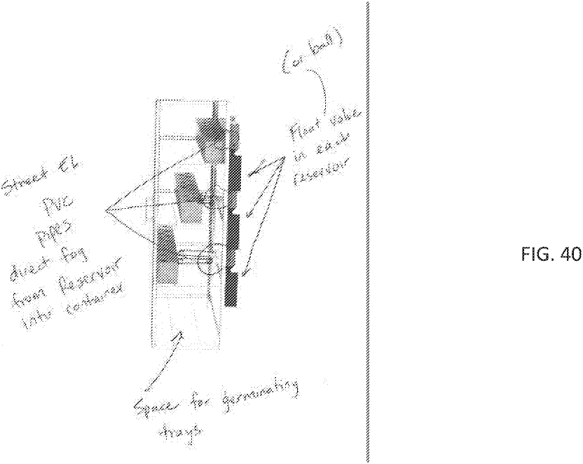

FIG. 36 shows an embodiment of a platform hosting a set of trays according to this disclosure. FIG. 37 shows an embodiment of a platform hosting a set of trays (containers) with a set of flora members according to this disclosure. FIG. 38 shows an embodiment of a platform hosting a set of trays (containers) with a set of flora members according to this disclosure. FIGS. 39A-39B show an embodiment of an assembly for growing a set of flora members according to this disclosure. FIG. 40 shows an embodiment of a platform hosting a set of trays (containers) with a set of flora members according to this disclosure.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, such as Smalltalk, C++ or the like, and conventional procedural programming languages, such as the “C” programming language, or similar programming languages. For example, some programming languages or computing systems can include Python, Postgres, or others. A code segment or machine-executable instructions may represent a procedure, a function, a subprogram, a program, a routine, a subroutine, a module, a software package, a firmware, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, and/or firmware, or combinations of both. To clearly illustrate this interchangeability of hardware and software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present disclosure.

The Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein. As used herein, the term “about” and/or “substantially” refers to a +/-10% variation from the nominal value/term. Such variation is always included in any given.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

1. A device comprising:
a tank storing a fluid;
a reservoir in a gravitational receipt of the fluid from the tank;
a mist source positioned within the reservoir such that the mist source generates a mist from the fluid contained in the reservoir based on the gravitational receipt;
a valve controlling the gravitational receipt based on the fluid in the reservoir;
a tray hosting a flora member; and
a tube conveying the mist from the reservoir to the tray such that the flora member is exposed to the mist.

2. The device of claim 1, wherein the valve is (a) a float valve having a float or (b) a ball valve having an opening, wherein the valve controls the gravitational receipt based on (a) the float rising or falling via the fluid in the reservoir or (b) the opening controlling a tension equilibrium between the fluid stored in the tank and the fluid contained in the reservoir.

3. The device of claim 1, wherein the tube has at least three elbow portions, wherein the mist is guided through the three elbow portions before the flora member is exposed to the mist.

4. The device of claim 3, wherein at least two of the three elbow portions are a single monolithic piece.

5. The device of claim 3, wherein the at least two of the three elbow portions are assembled with each other.

6. The device of claim 1, wherein the tube is a first tube, and further comprising:
a second tube in fluid communication with the tray and draining a volume of water from the tray, wherein the mist forms the volume of water in the tray.

7. The device of claim 1, wherein the reservoir and the container are vertically spaced apart from each other.

8. The device of claim 1, further comprising:
a lid covering the tray and extending over the tube.

9. The device of claim 1, wherein the tube is configured such that the mist flows horizontally immediately before the mist is output from the tube into the tray.

10. The device of claim 1, wherein the mist travels vertically against gravity before entering the tube.

12. The device of claim 1, wherein the gravitational receipt is a first gravitational receipt, wherein the reservoir is a first reservoir, wherein the mist source is a first mist source, wherein the valve is a first valve, wherein the tray is a first tray, wherein the mist is a first mist, wherein the flora member is a first flora member, wherein the tube is a first tube, and further comprising:
a second reservoir in a second gravitational receipt of the fluid from the tank;
a second mist source positioned within the second reservoir such that the second mist source generates a second mist from the fluid contained in the second reservoir based on the second gravitational receipt;
a second valve controlling the second gravitational receipt;
a second tray hosting a second flora member;
a second tube conveying the second mist from the second reservoir to the second tray such that the second flora member is exposed to the second mist;
a first fitting in the first gravitational receipt of the fluid from the tank and feeding the first reservoir with the fluid; and
a second fitting in the second gravitational receipt of the fluid from the tank and feeding the second reservoir with the fluid, wherein the second fitting is downstream the first fitting such that the first fitting is fluidly positioned between the tank and the second fitting.

13. The device of claim 12, further comprising:
a platform having a first level and a second level, wherein the second level extends over the first level, wherein the first tray extends over the first level, wherein the second tray extends over the second level.

14. The device of claim 1, further comprising:
a computer that instructs the mist source to generate the mist based on a schedule.

15. The device of claim 14, further comprising:
a sensor that generates an output based on sensing the flora member or a property of an ambient environment containing the flora member, wherein the computer controls the schedule based on the output.

16. The device of claim of 15, further comprising:
a light source that illuminates the flora member based on the schedule as instructed by the computer.

17. The device of claim 1, further comprising:
a camera that generates an imagery of the flora member; and
a computer that receives the imagery from the camera, processes the imagery, determines that an irrigation adjustment is necessary, and causes the mist source to generate the mist based on the irrigation adjustment.

18. The device of claim 17, further comprising:
a light source that illuminates the flora member based on the computer processing the imagery and determining that a lighting adjustment is necessary.

19. The device of claim 17, wherein the computer processes the imagery based on a machine-learning algorithm for at least the flora member.

20. A method comprising:
causing a valve to control a gravitational receipt of a fluid from a tank to a reservoir;
causing a mist to be generated from the fluid in the reservoir based on the gravitational receipt; and
causing the mist to be conveyed from the reservoir to a tray hosting a flora member such that the flora member is exposed to the mist.
